(19) United States
(12) Patent Application Publication
(10) Pub. No.: US 2026/0133530 A1
(43) Pub. Date: May 14, 2026

(54) IMAGE FORMING SYSTEM

(71) Applicant: CANON KABUSHIKI KAISHA, Tokyo (JP)

(72) Inventors: Taisuke Matsuura, Ibaraki (JP); Yuusuke Torimaru, Ibaraki (JP)

(21) Appl. No.: 19/369,674

(22) Filed: Oct. 27, 2025

(30) Foreign Application Priority Data
Nov. 14, 2024 (JP) 2024-198926
Jul. 8, 2025 (JP) 2025-115437

(51) Int. Cl. G03G 15/00; G03G 15/01; G03G 15/23

(52) U.S. Cl. CPC G03G 15/6558; G03G 15/0131; G03G 15/0189; G03G 15/234; G03G 15/5016; G03G 15/5029; G03G 15/6508; G03G 2215/00654

(57) ABSTRACT

An image forming system includes a first casing, a first conveyance path, a charging unit, a second casing, a second conveyance path, and an image forming unit. The first conveyance path is disposed inside the first casing and a sheet is conveyed through the first conveyance path. The charging unit is disposed inside the first casing and charges the sheet conveyed through the first conveyance path. The second conveyance path is disposed inside the second casing and the sheet conveyed through the first conveyance path is conveyed through the second conveyance path. The image forming unit is disposed inside the second casing. The image forming unit includes an image bearing member which bears the toner image, and a transfer portion which transfers the toner image formed on the image bearing member from the image bearing member to the sheet conveyed through the second conveyance path.

### BACKGROUND

### Field of the Technology

The present disclosure relates to an image forming system for forming images on sheets.

### Description of the Related Art

Hitherto, apparatuses are widely used as image forming apparatuses that adopt an electrophotographic system, in which toner images formed on image bearing members are superposed on a sheet and a transfer voltage is applied to transfer the superposed image onto the sheet, such that the toner images borne on the sheet are fixed to the sheet at a fixing portion to thereby acquire an output image. Among such transfer-type image forming apparatuses, the apparatus used for high-speed production has a greater variety of sheet types that may be used compared to apparatuses used in offices. Among such sheets, there are some sheets, such as synthetic paper and super-thick paper, that have specifically large electric resistances, such that when transferring a toner image onto a sheet having such a high electric resistance, an extremely high transfer voltage must be applied. Therefore, when using a sheet having a large electric resistance, the output value of secondary transfer high voltage may be insufficient.

In order to solve this problem, an image forming apparatus equipped with a sheet charging apparatus for charging a sheet in advance prior to a secondary transfer process is proposed (refer to Japanese Patent Application Laid-Open Publication No. 2013-171282). According to the image forming apparatus, an output value of secondary transfer high voltage in the secondary transfer process may be set to a low value compared to a case where sheet charging is not performed, such that a lack of secondary transfer high voltage when using a sheet having a large electric resistance may be compensated for.

However, there is room for further improvement in the image forming apparatus equipped with the sheet charging apparatus that charges the sheet in advance prior to the secondary transfer process.

### SUMMARY

The present disclosure provides a new technique related to an image forming system equipped with a transfer portion and a charging unit.

According to a first aspect of the present disclosure, an image forming system includes a first casing, a first conveyance path disposed inside the first casing and through which a sheet is conveyed, a charging unit disposed inside the first casing and configured to charge the sheet conveyed through the first conveyance path, a second casing configured to receive the sheet discharged from the first casing, a second conveyance path disposed inside the second casing and through which the sheet conveyed through the first conveyance path is conveyed, and an image forming unit configured to form a toner image on the sheet and disposed inside the second casing, the image forming unit including an image bearing member configured to bear the toner image, and a transfer portion configured to transfer the toner image formed on the image bearing member from the image bearing member to the sheet conveyed through the second conveyance path.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming system according to a first embodiment.

FIG. 2A is an explanatory view of a charged state of a sheet in the image forming system according to the first embodiment, illustrating a sheet after being charged.

FIG. 2B is an explanatory view of a charged state of the sheet in the image forming system according to the first embodiment, illustrating a sheet at a secondary transfer portion.

FIG. 3 is a cross-sectional view illustrating a sheet feeding apparatus and a sheet charging apparatus of the image forming system according to the first embodiment.

FIG. 4A is a cross-sectional view illustrating a sheet destaticizing apparatus of the image forming apparatus according to the first embodiment.

FIG. 4B is a table illustrating a relationship between sheet type and operation of various apparatuses.

FIG. 5 is a flowchart illustrating an operation procedure of the sheet charging apparatus and the sheet destaticizing apparatus in the image forming system according to the first embodiment.

FIG. 6 is a table illustrating a relationship regarding sheet type, operation of various apparatuses, and determination result of the image forming system according to the first embodiment.

FIG. 7A is an explanatory view of a charged state of the sheet in the image forming system according to the first embodiment, illustrating a sheet after secondary transfer according to Example 1.

FIG. 7B is an explanatory view of a charged state of the sheet in the image forming system according to the first embodiment, illustrating a sheet in an ideal destaticized state.

FIG. 7C is an explanatory view of a charged state of the sheet in the image forming system according to the first embodiment, illustrating a sheet after secondary transfer according to Example 2.

FIG. 8 is a cross-sectional view illustrating an image forming system according to a second embodiment.

FIG. 9 is a cross-sectional view illustrating a sheet feeding apparatus and a sheet charging apparatus of the image forming system according to the second embodiment.

FIG. 10 is a flowchart illustrating an operation procedure of the sheet charging apparatus in the image forming system according to the second embodiment.

FIG. 11 is a table illustrating a relationship between sheet type and whether to perform sheet charging according to feeding unit type in the image forming system according to the second embodiment.

FIG. 12 is a cross-sectional view illustrating a sheet feeding apparatus and a sheet charging apparatus of an image forming system according to a third embodiment.

FIG. 13 is a flowchart illustrating an operation procedure of the sheet charging apparatus in the image forming system according to the third embodiment.

FIG. 14A is a view of a screen of an operation portion of an image forming system according to a fourth embodiment, illustrating a state in which a main body_cassette 1 is selected.

FIG. 14B is a view of a screen of an operation portion of an image forming system according to a fourth embodiment, illustrating a state in which an external cassette is selected.

FIG. 15 is a flowchart illustrating an operation procedure of the sheet charging apparatus in the image forming system according to the fourth embodiment.

FIG. 16 is a view illustrating a screen of an operation portion of an image forming system according to a fifth embodiment.

FIG. 17 is a flowchart illustrating an operation procedure of a sheet charging apparatus in the image forming system according to the fifth embodiment.

### DESCRIPTION OF THE EMBODIMENTS

### First Embodiment

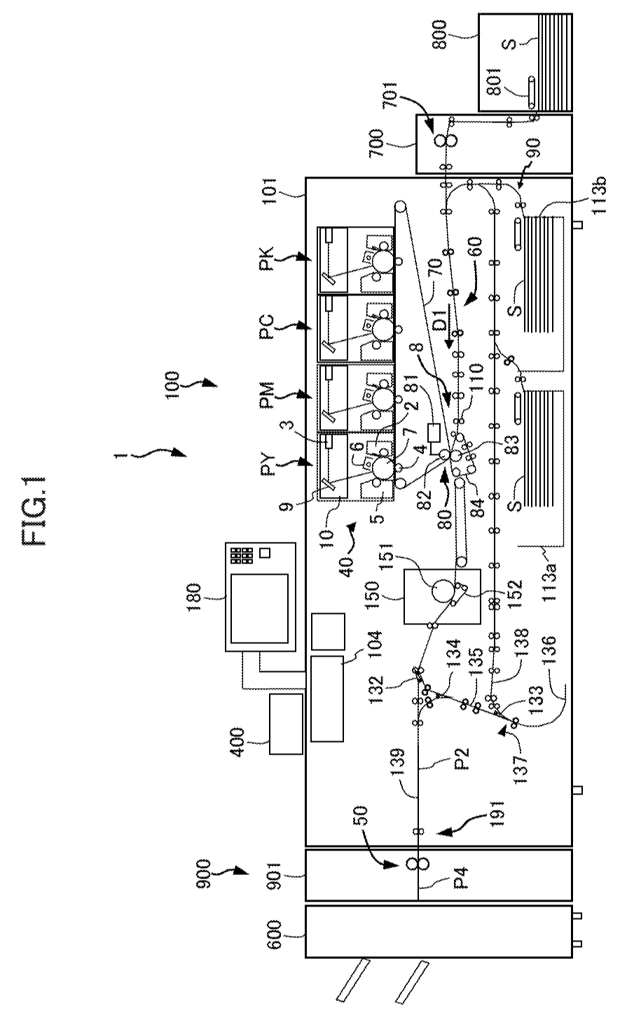

Now, a first embodiment of the present disclosure will be described in detail with reference to FIGS. 1 to 7C. At first, a schematic configuration of an image forming system 1 according to the present embodiment will be described with reference to FIG. 1. FIG. 1 is a cross-sectional view of the image forming system 1. The image forming system 1 includes a sheet feeding apparatus 800, a sheet charging apparatus 700, an image forming apparatus 100, a sheet destaticizing apparatus 900, and a sheet discharging apparatus 600, which are connected in the named order. In the present embodiment, the sheet charging apparatus 700 is one example of a first apparatus accommodating a sheet charging unit 701, the image forming apparatus 100 is one example of a second apparatus accommodating a secondary transfer portion 8, and the sheet destaticizing apparatus 900 is one example of a third apparatus accommodating a sheet destaticizing unit 50. The sheet charging apparatus 700 and the image forming apparatus 100 are connected to allow a sheet S to be conveyed from the sheet charging unit 701 to the secondary transfer portion 8. The image forming apparatus 100 and the sheet destaticizing apparatus 900 are connected to allow the sheet S to be conveyed from the secondary transfer portion 8 to the sheet destaticizing unit 50.

### Image Forming Apparatus

The image forming apparatus 100 uses an image forming process of an electrophotographic system to form an image on the sheet S. In the present embodiment, a full-color copying machine with a plurality of photosensitive drums is adopted. The present technique is not limited thereto, and a monochrome or mono-color copying machine or printer having one photosensitive drum may also be adopted. In addition to a laser beam printer, an electrophotographic device such as a digital copier, a color LED printer, a multifunction printer (MFP), a facsimile device, or a printing machine may be adopted as the image forming apparatus 100.

The image forming apparatus 100 is equipped with a second casing 101, which includes a reading unit 400, a sheet feeding unit 90, a conveyance portion 60 for conveying the sheet S in a sheet conveyance direction D1, an image forming unit 40, a sheet discharge portion 191, a control unit 104, and an operation portion 180. The operation portion 180 is formed of a liquid crystal panel, which may be operated by a user for setting image forming conditions of the image forming apparatus 100 and may display the state of the image forming apparatus 100. A temperature sensor for detecting an internal temperature of the device and a humidity sensor for detecting an internal humidity of the device are disposed inside the apparatus body. The image forming apparatus 100 can form a four-color full-color image on the sheet S, i.e., paper, transfer material, or recording medium, according to an image information from the reading unit 400 or an external apparatus. The external apparatus may be, for example, a host device such as a personal computer, a digital camera, or a smartphone.

The image forming apparatus 100 conveys the sheet S fed from the sheet feeding unit 90 or the sheet feeding apparatus 800 by the conveyance portion 60 to the image forming unit 40, and forms a toner image on the sheet S. The conveyance portion 60 includes a plurality of rollers, a motor for driving the rollers, and a guide portion. The image forming apparatus 100 conveys the sheet S to which a toner image has been formed by the image forming unit 40 to a fixing unit 150, where heat and pressure are applied to fix the unfixed toner on the sheet S onto the sheet S. The sheet S may include paper such as thin paper and thick paper, plastic films made of synthetic resin such as overhead projector (OHP) sheets, coated paper or other paper having surface treatment applied thereto, sheets having special shapes such as envelopes, and cloths.

The image forming unit 40 includes stations PY, PM, PC, and PK, in which images are formed to the sheet S conveyed by the conveyance portion 60. The stations PY, PM, PC, and PK respectively form toner images of yellow, magenta, cyan, black on an intermediate transfer belt 70. The configurations of the stations PY, PM, PC, and PK are the same, except for the difference in toner colors. Therefore, the configuration of the station PY will be described as a representative example, and the configurations of other stations PM, PC, and PK will be omitted.

The station PY includes a photosensitive drum 7 that rotates. The photosensitive drum 7 is an example of an image bearing member that bears a toner image on a surface thereof. A charging unit 6, a laser scanner 10, a developing unit 5, and a primary transfer roller 4 are disposed around the photosensitive drum 7. The charging unit 6 charges the surface of the photosensitive drum 7 uniformly. The laser scanner 10 includes a semiconductor laser 3 and a reflecting mirror 9. Laser light irradiated from the semiconductor laser 3 according to the image data supplied from the control unit 104 is deflected in a main scanning direction by a rotary polygon mirror (not shown). The laser light deflected in the main scanning direction is guided to the surface of the photosensitive drum 7 by a reflecting mirror 109, and exposes the uniformly charged surface of the photosensitive drum 7 in the main scanning direction. Thereby, an electrostatic latent image is formed on the surface of the photosensitive drum 7 according to the image data.

The developing unit 5 develops the electrostatic latent image on the surface of the photosensitive drum 7 using yellow (Y) toner, and forms a yellow (Y) toner image. A voltage having a reverse polarity as that of the toner image is applied to the primary transfer roller 4, and the yellow (Y) toner image on the surface of the photosensitive drum 7 is primarily transferred onto the intermediate transfer belt 70. The intermediate transfer belt 70 is one example of an intermediate transfer body to which the toner image is primarily transferred from the photosensitive drum 7. Similarly, a magenta (M) toner image, a cyan (C) toner image, and a black (K) toner image that have been formed by the magenta station PM, the cyan station PC, and the black station PK are sequentially transferred onto the intermediate transfer belt 70. Yellow (Y), magenta (M), cyan (C), and black (K) toner images are superposed and transferred onto the intermediate transfer belt 70, and a full-color toner image is formed. The intermediate transfer belt 70 is rotatably supported by a plurality of rollers including a secondary transfer inner roller 82.

Meanwhile, the sheet S fed from the sheet feeding unit 90 or the sheet feeding apparatus 800 is conveyed via the conveyance portion 60 to the secondary transfer portion 8. The sheet feeding unit 90 feeds sheets supported on sheet cassettes 113a and 113b. The secondary transfer portion 8 includes a transfer roller pair 80, and a third voltage adjustment portion 81. The transfer roller pair 80 includes the secondary transfer inner roller 82 and a secondary transfer outer roller 83, and forms a secondary transfer nip portion which is a nip portion that nips the sheet S and the intermediate transfer belt 70. The intermediate transfer belt 70 and a secondary transfer belt 84 are nipped between and rotated by the secondary transfer inner roller 82 and the secondary transfer outer roller 83. A registration roller 110 of the conveyance portion 60 feeds the sheet S to the secondary transfer nip portion in a synchronized manner with the conveyance of the toner image on the intermediate transfer belt 70 to the secondary transfer nip portion.

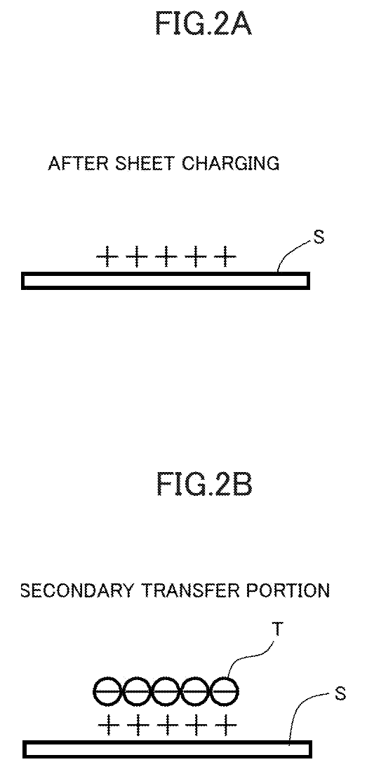

The secondary transfer outer roller 83 is connected to an earth. The secondary transfer inner roller 82 is connected via the third voltage adjustment portion 81 to a high voltage power supply not shown. The third voltage adjustment portion 81 adjusts the voltage between rollers of the transfer roller pair 80. By having a voltage of a negative polarity, which is the same polarity as toner, to the secondary transfer inner roller 82 from the third voltage adjustment portion 81, the toner image on the intermediate transfer belt 70 is secondarily transferred to the sheet S supplied to the secondary transfer nip portion. That is, the secondary transfer portion 8 performs transfer such that a surface, i.e., printing surface, of the sheet on which the toner image is transferred has a negative polarity (refer to FIG. 2B). The secondary transfer portion 8 is an example of a transfer portion, which is disposed downstream of the sheet charging apparatus 700 in the sheet conveyance direction D1, and by having a voltage applied to the transfer roller pair 80, the toner image is secondarily transferred from the intermediate transfer belt 70 to the sheet S.

A roller composed of an elastic layer formed of ion conductive foam rubber (NBR rubber) and a core metal with an outer diameter of 24 mm and a roller surface roughness of Rz = 6.0 to 12.0 (μm) is used as the secondary transfer outer roller 83. The secondary transfer outer roller 83 has a resistance value of 1.0 × 10⁵ to 1.0 × 10⁷ (Ω) by N/N (23°C, 50% RH) measurement and 2 kV application, and an elastic layer hardness of 30 to 40 in Asker-C hardness. The secondary transfer belt 84 uses a belt in which an appropriate amount of carbon black is contained as antistatic agent in resin such as polyimide or polycarbonate and having a volume resistivity of 1.0×10⁹ to 1.0×10¹⁴ (Ω∙cm) and a thickness of 0.07 to 0.1 (mm). A Young’s modulus value of the secondary transfer belt 84 is approximately 100 MPa or more and 10 GPa or less when measured by a tensile testing method (JIS K 6301), which is sufficiently hard.

The image forming apparatus 100 includes the fixing unit 150 for fixing the toner image transferred onto the sheet S. The sheet S separated from a secondary transfer nip portion N is conveyed to the fixing unit 150 by a conveyor belt disposed downstream in the sheet conveyance direction D1. The fixing unit 150 is an example of a fixing portion, arranged on the conveyance path of the sheet S from the secondary transfer portion 8 to the sheet destaticizing apparatus 900, and applies heat and pressure to the sheet S to which the toner image has been transferred to fix the toner image onto the sheet S. The fixing unit 150 includes a fixing roller 151 for applying heat to the sheet S, and a pressing belt 152 for having the sheet S come into pressure contact with the fixing roller 151. The fixing roller 151 is a hollow roller having a heater disposed therein, which is driven to rotate and convey the sheet S.

In the case of duplex printing, the sheet S reverses the sheet S having finished printing on one side to convey the sheet again to the image forming unit 40. Specifically, the sheet S after having the image fixed thereto is guided by a switching unit 132 to a conveyance path 135 and conveyed to a reverse portion 136. When a trailing edge of the sheet S is detected by a reverse sensor 137, a switching unit 133 switches the conveyance direction of the sheet S to a conveyance path 138. The reversed sheet S is conveyed via the conveyance path 138 again to the image forming unit 40 and then to the fixing unit 150. The sheet S having finished printing to both sides is guided by the switching unit 132 to a sheet discharge path 139 and discharged to the exterior.

### Sheet Feeding Apparatus and Sheet Discharge Apparatus

The sheet feeding apparatus 800 stacks and stores a plurality of sheets S. The sheet feeding apparatus 800 includes a suction-type conveyance belt 801, and feeds the sheets S being stored therein from an uppermost sheet to the sheet charging apparatus 700. The sheet discharging apparatus 600 is an apparatus that discharges the sheet S on which an image is formed to the sheet discharge tray and stacks the sheet S thereon. The sheet discharging apparatus 600 is not limited to an apparatus that simply stacks the sheets S, and it may be a postprocessing apparatus that performs postprocessing such as stapling, hole punching, and sorting.

### Sheet Charging Apparatus

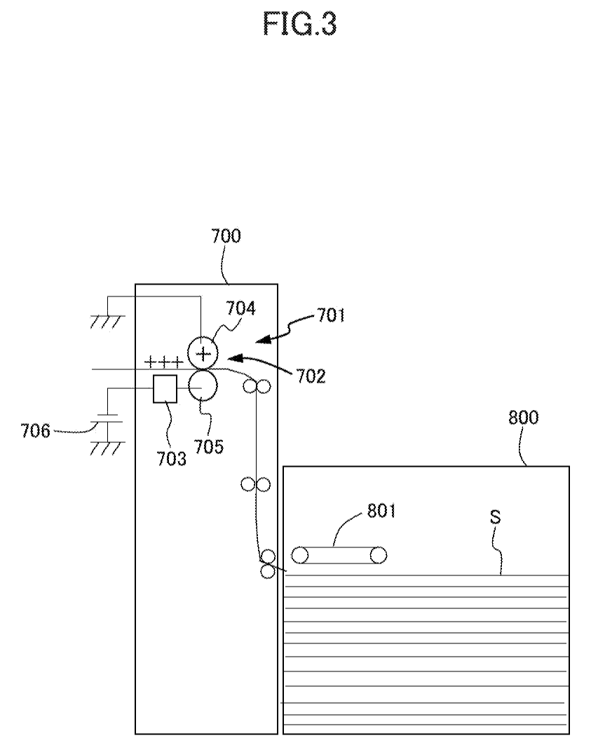

Next, the sheet charging apparatus 700 will be described with reference to FIGS. 2A to 3. In a high-speed production apparatus such as the image forming system 1 according to the present embodiment, various types of sheets are required to be output without deteriorating the productivity. However, in order to perform appropriate toner transfer without deteriorating the productivity when using a sheet having a high electric resistance value, such as super-thick paper and synthetic paper, a high transfer voltage corresponding to the electric resistance of the sheet must be applied. Further, the electric resistance value of the transfer roller pair 80 of the secondary transfer portion 8 tends to be increased in a low temperature and low humidity environment, whereas in such an environment, in order to obtain the desired transfer current, the transfer voltage value being applied must be set high. Therefore, depending on the sheet type being used, the transfer voltage value being applied may even be set to 10 kV or more.

However, a high voltage power supply capable of applying a high transfer voltage value is expensive, and in a case where a creepage distance cannot be ensured due to circumstances of arrangement of components inside the apparatus, it is necessary to limit the voltage value that may be applied. Further, when the application voltage is increased, abnormal discharge tends to occur at the secondary transfer nip portion, and the risk of occurrence of image defects such as void images caused by the inversion of toner polarity may increase.

Therefore, according to the present embodiment, in order to use a sheet S having such a high electric resistance, the surface, i.e., printing surface, of the sheet is charged to opposite polarity as the polarity of toner in advance by the sheet charging apparatus 700, as illustrated in FIG. 2A, before the sheet S reaches the secondary transfer nip portion. That is, the sheet charging apparatus 700 charges the printing surface of the sheet to opposite polarity as the charge polarity of toner. Then, as illustrated in FIG. 2B, by performing secondary transfer to the charged sheet S and transferring toner T to the sheet S, the voltage value to be applied during secondary transfer may be reduced compared to the case where the sheet is not charged in advance. Thereby, abnormal discharge image that tends to occur when secondary transfer voltage is increased may be prevented.

As illustrated in FIG. 3, the sheet charging apparatus 700 has a casing, and the casing accommodates the sheet charging unit 701. The sheet charging unit 701 is an example of a charging unit that charges the sheet S, and includes a charging roller pair 702 that nips and conveys the sheet S, and a second voltage adjustment portion 703 that adjusts the voltage between rollers of the charging roller pair 702. The charging roller pair 702 includes a sheet charging roller 704, and a sheet charging counter roller 705. The sheet charging roller 704 is connected to the earth. The sheet charging counter roller 705 is connected via the second voltage adjustment portion 703 to a high voltage power supply 706. The second voltage adjustment portion 703 adjusts the voltage between rollers of the charging roller pair 702. The sheet charging unit 701 charges the sheet S by having a DC bias of negative polarity applied at a timing at which the sheet S passes the nip of the charging roller pair 702 according to a value set in advance according to the sheet type and the apparatus environment. According to the present embodiment, the sheet charging unit 701 performs charging such that the printing surface of the sheet S is charged to positive polarity.

### Sheet Destaticizing Apparatus

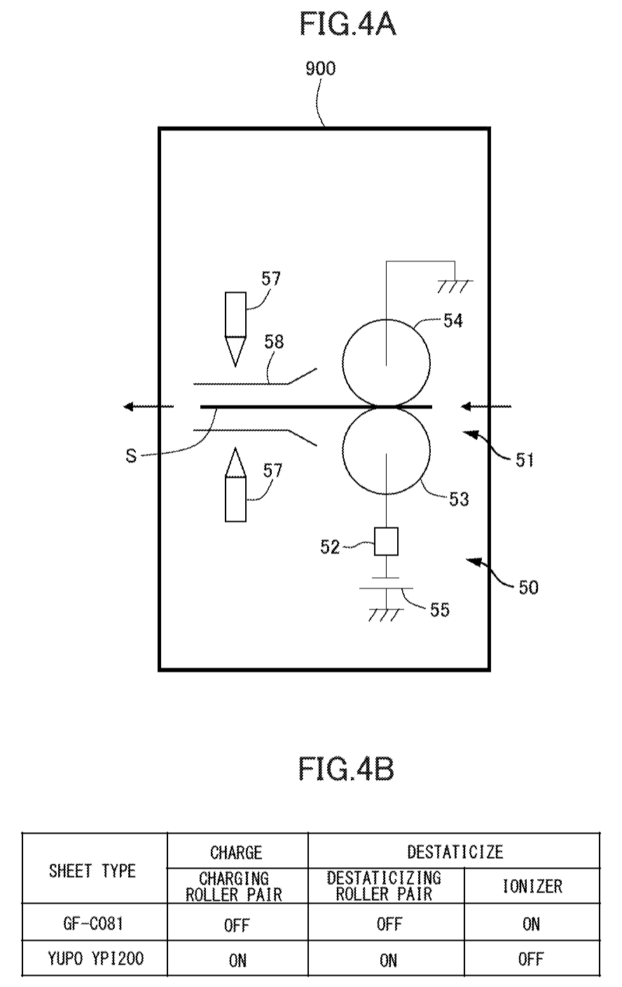

Next, the sheet destaticizing apparatus 900 will be described with reference to FIGS. 4A and 4B. The sheet destaticizing apparatus 900 is arranged and connected downstream of the image forming apparatus 100 in the sheet conveyance direction D1, and receives the sheet S to which the image has been formed from the image forming apparatus 100 and destaticizes the sheet S. As illustrated in FIG. 4A, the sheet destaticizing apparatus 900 includes a casing, and the sheet destaticizing unit 50 is accommodated in the case. The sheet destaticizing unit 50 is an example of a destaticizing unit that destaticizes the sheet S, and includes a destaticizing roller pair 51 that nips and conveys the sheet S, a first voltage adjustment portion 52 that adjusts the voltage between rollers of the destaticizing roller pair 51, and a pair of ionizers 57 that sandwich the conveyance path of the sheet S from upper and lower directions. The destaticizing roller pair 51 includes a sheet destaticizing roller 53 and a sheet destaticizing counter roller 54. The sheet destaticizing counter roller 54 is connected to the earth. The sheet destaticizing roller 53 is connected via the first voltage adjustment portion 52 to a high voltage power supply 55. The first voltage adjustment portion 52 adjusts the voltage between rollers of the destaticizing roller pair 51. The sheet destaticizing unit 50 destaticizes the sheet S such that the printing surface of the sheet S is set to positive polarity.

A roller composed of an elastic layer formed of ion conductive foam rubber and a core metal with an outer diameter of 20 to 25 mm is used as the sheet destaticizing roller 53. The sheet destaticizing roller 53 has a resistance value of 1 × 10⁵ to 1 × 10⁸ (Ω) by 2 kV application measured at 23°C and 50% RH environment. A roller having a SUS property and an outer diameter of 20 to 25 mm is used as the sheet destaticizing counter roller 54, and by arranging the roller to face the sheet destaticizing roller 53, a destaticizing nip is formed. By operating a switch of destaticizing voltage (not shown), the user can switch between an on state where voltage is applied to the destaticizing roller pair 51 and an off state where voltage is not applied thereto.

The ionizers 57 are devices that destaticize the sheet S by generated ions, which are arranged downstream of the destaticizing roller pair 51 in the sheet conveyance direction D1, and in which bar-type IZS40 (product of SMC Corporation) are disposed above and below the sheet S. A synthetic resin composed of polycarbonate (PC) and acrylonitrile-butadiene-styrene (ABS) is adopted as conveyance guides 58 arranged to face the ionizers 57. The volume resistivity of the conveyance guide 58 is 1×10¹⁴ (Ω∙cm). Further, holes that pass through from the upper side to the lower side are respectively disposed on the conveyance guides 58 disposed on upper and lower sides such that the ions generated in the ionizers 57 are not physically blocked by the conveyance guides 58.

The sheet S conveyed from the image forming apparatus 100 is subjected to rough charge removal at the destaticizing nip portion of the destaticizing roller pair 51 formed of the sheet destaticizing roller 53 and the sheet destaticizing counter roller 54. The high voltage applied to the sheet destaticizing roller 53 is applied with negative polarity which is the same polarity as the voltage applied to the secondary transfer inner roller 82. Specifically, a voltage of -1 to -6 kV is applied. Next, the sheet S is destaticized by the ionizers 57 disposed further downstream, and the sheet S is discharged to the exterior of the sheet destaticizing apparatus 900.

FIG. 4B illustrates on/off states of charging and destaticizing by the charging roller pair 702, the destaticizing roller pair 51, and the ionizer 57 according to sheet type. The on/off setting of charging and destaticizing at various units is performed at 23°C and a low humidity environment of 5% RH. As an example, as the sheet types, normal paper GF-C081 (product of Canon Inc.) was adopted as normal paper, and YPI200 (product of YUPO Corporation) was adopted as synthetic paper. When normal paper GF-C081 is used, the charging roller pair 702 and the destaticizing roller pair 51 are set to voltage application off, and the ionizers 57 are set to destaticizing on. Meanwhile, when YPI200 is used, the charging roller pair 702 and the destaticizing roller pair 51 are set to voltage application on, and the ionizers 57 are set to destaticizing off.

In this state, according to the present embodiment, the configurations of the charging roller pair 702 and the destaticizing roller pair 51 are common, and members having the same configuration are applied. Similarly, the configurations of the second voltage adjustment portion 703 and the first voltage adjustment portion 52 are common, and members having the sane configuration are applied. Therefore, increase in variety of members can be suppressed compared to a case where the members are not made common, such that increase of costs may be suppressed. In the present embodiment, both the charging roller pair 702 and destaticizing roller pair 51, and the second voltage adjustment portion 703 and first voltage adjustment portion 52, have common configurations, but the present technique is not limited thereto. For example, only either one of the charging roller pair 702 and destaticizing roller pair 51 or the second voltage adjustment portion 703 and first voltage adjustment portion 52 may have a common configuration. Even in that case, the increase in variety of members can be suppressed compared to the case where the members are not made common, and increase of costs may be suppressed. In other words, at least either of the charging roller pair 702 and destaticizing roller pair 51 or the second voltage adjustment portion 703 and first voltage adjustment portion 52 has a common configuration.

### Control Unit

The control unit 104 includes a CPU and a memory not shown. The memory may include a nonvolatile memory (ROM), a nonvolatile memory (RAM), a solid state drive (SSD), and a hard disk drive (HDD). The CPU controls the conveyance portion 60, the sheet charging unit 701, the secondary transfer portion 8, and the sheet destaticizing unit 50 according to a control program stored in a ROM region of the memory. The present disclosure is not limited to having the control unit 104 disposed in the image forming apparatus 100 directly control the sheet charging unit 701 and the sheet destaticizing unit 50. For example, the control unit 104 may output a command to a control unit disposed in the sheet charging apparatus 700, and the control unit disposed in the sheet charging apparatus 700 may be used to control the sheet charging unit 701. Similarly, the control unit 104 may output a command to a control unit disposed in the sheet destaticizing apparatus 900, and the control unit disposed in the sheet destaticizing apparatus 900 may be used to control the sheet destaticizing unit 50.

According to the image forming apparatus described in Japanese Patent Application Laid-Open Publication No. 2013-171282, for example, in the case of films and synthetic paper that adopt resin-based material or of fine paper or coated paper formed of resin material, the sheets, which may even be a generally-used paper, may be easily charged when left in a low humidity environment. Therefore, when stacking sheets discharged from the image forming apparatus, the sheets may be electrostatically attracted to each other, such that alignment of sheets may be obstructed and the stackability may be deteriorated. Therefore, the present embodiment provides the image forming system 1 that may improve the transferability of toner to a sheet having a large electric resistance and may ease the electrostatic attraction between sheets after transfer to improve the stackability.

### Sheet Charging and Sheet Destaticizing Operation

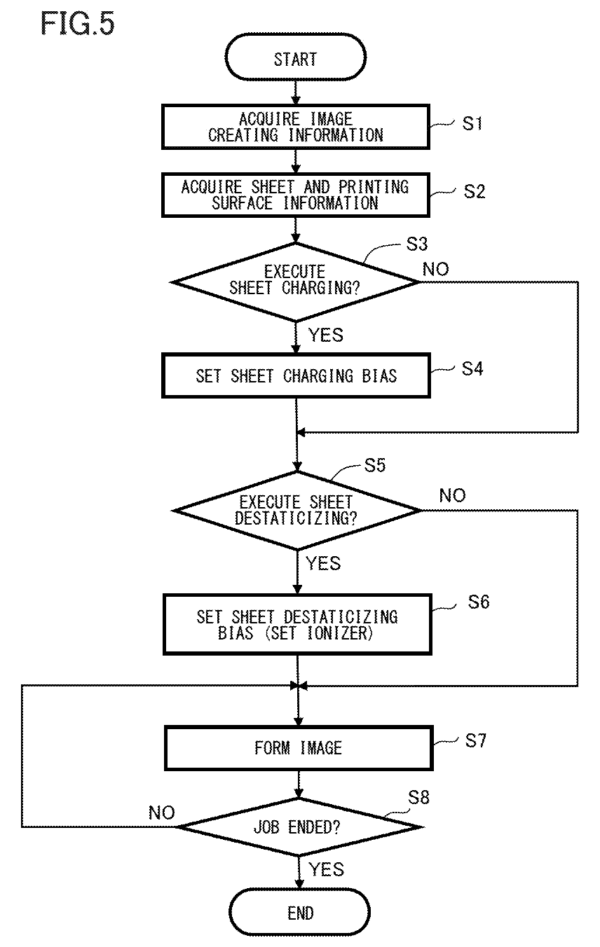

Next, a sheet charging and sheet destaticizing operation procedure of the image forming system 1 will be described according to a flowchart illustrated in FIG. 5. The following description illustrates a case in which the sheet S is fed from the sheet feeding apparatus 800.

When the user enters an image forming job using the operation portion 180, the control unit 104 starts an image forming operation. The control unit 104 acquires an image creating information regarding the image information and the number of prints of the image forming job entered by the user (S1), and acquires information regarding the sheet type to be used and the printing surface selected by the user (S2).

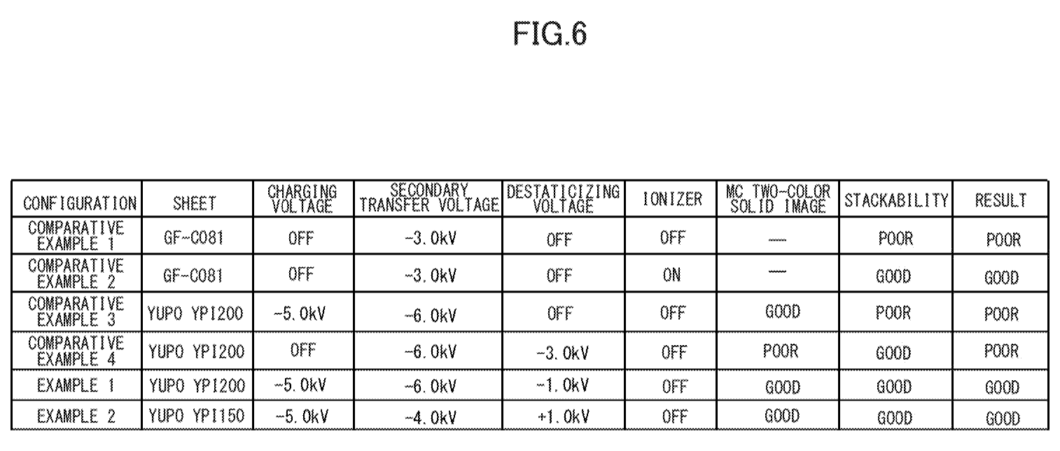

The control unit 104 determines whether to perform sheet charging based on the acquired sheet type and circumference environment information related to temperature and humidity (S3). In the present example, the control unit 104 determines whether to perform sheer charging based on an execution requirement of sheet charging and sheet destaticizing set in advance (refer for example to FIG. 6).

When it is determined that sheet charging is to be performed (S3; YES), the control unit 104 sets an output value of a sheet charging bias to the charging roller pair 702 (S4). The output value according to the present example is set in advance by a table value according to the sheet type and apparatus environment, and a DC constant voltage value corresponding to the table value is set as the output value.

If it is determined that sheet charging is not to be performed (S3; NO), or if the output value of the sheet charging bias is set (S4), the control unit 104 determines whether to perform sheet destaticizing (S5). In the present example, the control unit 104 determines whether to perform sheet destaticizing based on the execution requirement of sheet charging and destaticizing set in advance (refer for example to FIG. 6).

When it is determined that sheet destaticizing is to be performed (S5; YES), the control unit 104 sets the output value of the sheet destaticizing bias to the destaticizing roller pair 51 or to set the operation of the ionizers 57 (S6). In this state, the control unit 104 sets whether to execute only the sheet destaticizing bias to the destaticizing roller pair 51, to execute only the operation of the ionizers 57, or to perform both operations based on the execution requirement. The output value described above is set in advance by a table value according to the sheet type and apparatus environment, and a DC constant voltage value according to the table value is set as the output value.

When it is determined that sheet destaticizing is not to be performed (S5; NO), or if the output value of the sheet destaticizing bias or the operation of the ionizers 57 is set (S6), the control unit 104 feeds the sheet S and executes image forming (S7). After image forming is ended, the control unit 104 determines whether the image forming job has ended (S8). If it is determined that the image forming job has not ended (S8; NO), the control unit 104 executes image forming again (S7). If it is determined that the image forming job has ended (S8; YES), the control unit 104 ends the processing.

According to the present embodiment, the control unit 104 can execute three operation procedures, third to fifth modes, selectively in the image forming operation of S7.

A third mode is a mode for charging the sheet S by the sheet charging unit 701, transfer the toner image by the secondary transfer portion 8 to the sheet S charged by the sheet charging unit 701, and destaticize the sheet S to which the toner image has been transferred by the secondary transfer portion 8 using the sheet destaticizing unit 50. In this case, the control unit 104 charges the sheet S by applying the voltage having the determined output value from the high voltage power supply 706 via the second voltage adjustment portion 703 to the charging roller pair 702 at a timing at which the sheet S has reached the charging roller pair 702. The control unit 104 conveys the charged sheet S to the image forming apparatus 100 and executes image forming. Thereafter, at a timing at which the sheet S reaches the destaticizing roller pair 51, the control unit 104 applies the voltage having the determined output value from the high voltage power supply 55 via the first voltage adjustment portion 52 to the destaticizing roller pair 51 to thereby execute destaticizing of the sheet S. Then, the destaticized sheet S is discharged from the sheet discharging apparatus 600. The control unit 104 executes the third mode, for example, in a case where the sheet is a synthetic paper in which the transfer bias at the secondary transfer portion 8 is great and which has a high electric resistance that requires destaticizing.

A fourth mode is a mode for transferring a toner image by the secondary transfer portion 8 to a sheet S that is not charged by the sheet charging unit 701, and destaticizing the sheet S to which the toner image has been transferred by the secondary transfer portion 8 using the sheet destaticizing unit 50. In this case, the control unit 104 allows the sheet S fed from the sheet feeding apparatus 800 to pass through the charging roller pair 702 in a state where charge bias is not applied. The control unit 104 conveys the non-charged sheet S to the image forming apparatus 100 and executes image forming. Thereafter, at a timing at which the sheet S reaches the destaticizing roller pair 51, the control unit 104 applies the voltage having the determined output value from the high voltage power supply 55 via the first voltage adjustment portion 52 to the destaticizing roller pair 51, to thereby destaticize the sheet S. Then, the destaticized sheet S is discharged from the sheet discharging apparatus 600. The control unit 104 executes the fourth mode, for example, in a case where the sheet is a synthetic paper in which the transfer bias at the secondary transfer portion 8 is not so great and that requires destaticizing.

It is assumed that an absolute value of voltage set for the destaticizing roller pair 51 when executing the third mode is a first value. In this case, an absolute value of voltage set for the destaticizing roller pair 51 when executing the fourth mode is a second value that is greater than the first value. Specifically, in Example 1 described below (refer to FIG. 6), the third mode is executed, wherein the voltage set for the destaticizing roller pair 51 is -1.0 kV, and the absolute value, i.e., first value, thereof is 1.0. In Comparative Example 4 described below (refer to FIG. 6), the fourth mode is executed, wherein the voltage set for the destaticizing roller pair 51 is -3.0 kV, and the absolute value, i.e., second value, thereof is 3.0. As described, the second value is greater than the first value. Thereby, in the fourth mode where sheet charging is not executed, the sheet destaticizing voltage must be set greater than the third mode that executes sheet charging.

A fifth mode is a mode for transferring a toner image by the secondary transfer portion 8 to a sheet S that is not charged by the sheet charging unit 701, and the sheet S to which the toner image has been transferred by the secondary transfer portion 8 is not destaticized by the sheet destaticizing unit 50. In this case, the control unit 104 allows the sheet S fed from the sheet feeding apparatus 800 to pass through the charging roller pair 702 without having charge bias applied thereto. The control unit 104 conveys the non-charged sheet S to the image forming apparatus 100 and executes image forming. Thereafter, the control unit 104 allows the sheet to pass through the destaticizing roller pair 51 without having destaticizing bias applied thereto, and discharges the sheet from the sheet discharging apparatus 600. The control unit 104 executes the fifth mode, for example, in a case where the sheet is a normal paper in which the transfer bias at the secondary transfer portion 8 is not so great and that does not require destaticizing.

### Examples and Comparative Examples

Image forming was performed using the image forming system 1 described above. Various conditions, including sheet type, whether to charge the sheet, whether to destaticize the sheet, were varied. The results are shown in FIG. 6. The various conditions illustrated in FIG. 6 are merely examples, and the present technique is not limited thereto.

### Comparative Example 1

In Comparative Example 1, normal paper GF-C081 was used as the sheet, charging and destaticizing of the sheet were not executed, and continuous sheet passing of 100 sheets was performed under a temperature and humidity environment of 23°C and 5% RH. In this case, the charged sheets were electrostatically repulsed with each other on the stacking tray after being discharged, and stacking failure occurred.

### Comparative Example 2

In Comparative Example 2, only the condition that the ionizer 57 is turned on differs from the conditions of Comparative Example 1, and other conditions were the same as the Comparative Example 1. In this case, repulsion of charged sheets did not occur, and there was no problem in stackability.

### Comparative Example 3

In Comparative Example 3, YPI200 was used as the sheet, sheet charging was executed while sheet destaticizing was not executed, and continuous sheet passing of 20 sheets was performed under a temperature and humidity environment of 23°C and 5% RH. In this case, the charged sheets were electrostatically attracted to each other on the stacking tray after being discharged, and stacking failure occurred.

### Comparative Example 4

In Comparative Example 4, YPI200 was used as the sheet, sheet charging was not executed while sheet destaticizing was executed, and continuous sheet passing of 20 sheets was performed under a temperature and humidity environment of 23°C and 5% RH. In this case, the toner transferability of MC two-color solid image was insufficient.

### Example 1

In Example 1, YPI200 was used as the sheet, sheet charging and sheet destaticizing were executed, and continuous sheet passing of 20 sheets was performed under a temperature and humidity environment of 23°C and 5% RH. In this case, no problems occurred in the toner transferability of MC two-color solid image and the stackability after sheet discharge.

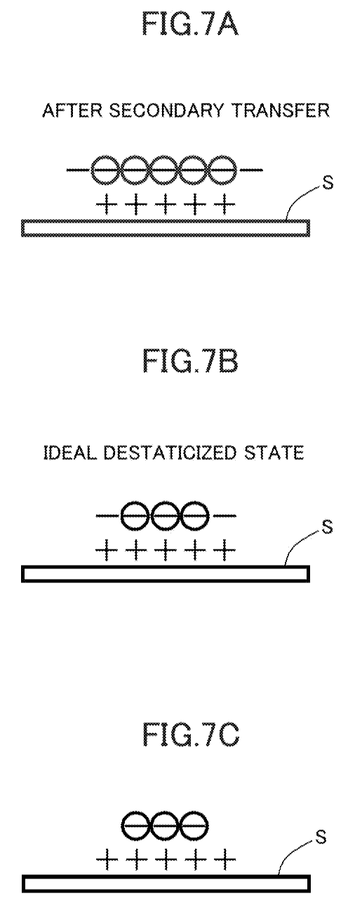

FIG. 7A schematically illustrates an electric charge on the surface of the sheet S after the secondary transfer process according to Example 1. As illustrated in FIG. 7B, an ideal state is where electric charge of positive polarity and electric charge of negative polarity are balanced, whereas actually, the electric charge is biased to either one of the polarities, and in the present embodiment, the electric charge is biased to negative polarity as illustrated in FIG. 7A. The back surface of the sheet S maintains an electric charge of positive polarity, and therefore, high-resistance media, a typical example of which is synthetic paper such as YPI200, will be electrostatically attracted to each other on the stacking tray and the stackability of the sheets may occur.

In order to solve this problem, according to the present embodiment, -1.0 kV bias was applied to the destaticizing roller pair 51 to perform destaticizing. This operation enables to lower the absolute value compared to -3.0 kV applied in Comparative Example 4. According to Example 1 and Comparative Example 4, by executing the sheet destaticizing step, it is considered that a state close to the ideal destaticized state illustrated in FIG. 7B was realized, such that there was no problem in stackability. By executing the sheet charging and sheet destaticizing steps as illustrated in Example 1 described above, it was confirmed that both transferability and sheet stackability may be realized in high-resistance media such as synthetic paper and normal paper.

### Example 2

In Example 2, YPI150 (product of YUPO Corporation) was used as the sheet, sheet charging and sheet destaticizing were executed, and continuous sheet passing of 20 sheets was performed under a temperature and humidity environment of 23°C and 5% RH. The difference from Example 1 was the sheet type, and the sheet of Example 2, which is YPI150, is thinner than the sheet (YPI200) used in Example 1. Therefore, in Example 2, the secondary transfer voltage was lowered from -6.0 kV to -4.0 kV since the thickness of the sheet S was thin.

FIG. 7C schematically illustrates an electric charge on the surface of the sheet S after the secondary transfer process according to Example 2. As illustrated in FIG. 7C, since the secondary transfer voltage was lowered to -4.0 kV from -6.0 kV, the total electric charge on the surface of the sheet S was of positive polarity. Therefore, the sheet destaticizing voltage was set to +1.0 kV. In this case, no problem occurred in the toner transferability of MC two-color solid image and stackability after sheet discharge. By executing sheet charging and sheet destaticizing as according to Example 2 described above, it was confirmed that both transferability and sheet stackability may be realized in high-resistance media such as synthetic paper and normal paper.

As described above, the image forming system 1 according to the present embodiment includes the sheet charging unit 701, the secondary transfer portion 8, and the sheet destaticizing unit 50, and the control unit 104 is capable of executing a third mode in which image forming is performed to a charged sheet S and destaticizing is performed thereto. Therefore, lack of secondary transfer high voltage when using a large electric resistance sheet is used may be compensated for, and electrostatic attraction between sheets discharged from the image forming apparatus may be suppressed. Thereby, toner transferability of sheets having a large electric resistance may be improved, and stackability of sheets after transfer may also be improved.

According further to the sheet destaticizing apparatus 900 of the present embodiment, the sheet destaticizing unit 50 includes the ionizers 57 in addition to the destaticizing roller pair 51. Therefore, a two-step destaticizing may be executed, which are a rough destaticizing of a large voltage by the destaticizing roller pair 51 and a high-accuracy destaticizing of a small voltage by the ionizers 57, such that a highly accurate destaticizing may be realized.

The embodiment described above illustrated a case where a DC constant voltage bias is applied to the charging roller pair 702 and the destaticizing roller pair 51, but the present technique is not limited thereto, and the use of a DC constant current bias or the superposing of an AC voltage current may also be performed.

According to the embodiment described above, a bias of negative polarity was applied to the sheet charging counter roller 705 to have the surface of the sheet S charged to positive polarity, but the present technique is not limited thereto. For example, a bias of positive polarity may be applied to the sheet charging roller 704 to have the surface of the sheet S charged to positive polarity. Similarly, according to the embodiment described above, a bias of negative polarity was applied to the sheet destaticizing roller 53 to destaticize the sheet S, but the present technique is not limited thereto. For example, a bias of positive polarity may be applied to the sheet destaticizing counter roller 54 to destaticize the sheet S.

According further to the embodiment described above, a contact charging system for applying voltage to the charging roller pair 702 was adopted considering energy conversion efficiency and ozone generation amount, but the present technique is not limited thereto. For example, a configuration that includes a roller and a conductive brush, instead of the roller pair, or a non-contact charging system using corona discharge, may also be applied.

According further to the embodiment described above, the sheet charging apparatus 700 and the sheet destaticizing apparatus 900 are each connected as an external apparatus to the image forming apparatus 100, but the present technique is not limited thereto. For example, the sheet charging unit 701 may be disposed inside the image forming apparatus 100 while the sheet destaticizing apparatus 900 is attached as an external apparatus, or the sheet destaticizing unit 50 may be disposed inside the image forming apparatus 100 while the sheet charging apparatus 700 is attached as an external apparatus. Alternatively, both the sheet charging unit 701 and the sheet destaticizing unit 50 may be disposed inside the image forming apparatus 100.

### Second Embodiment

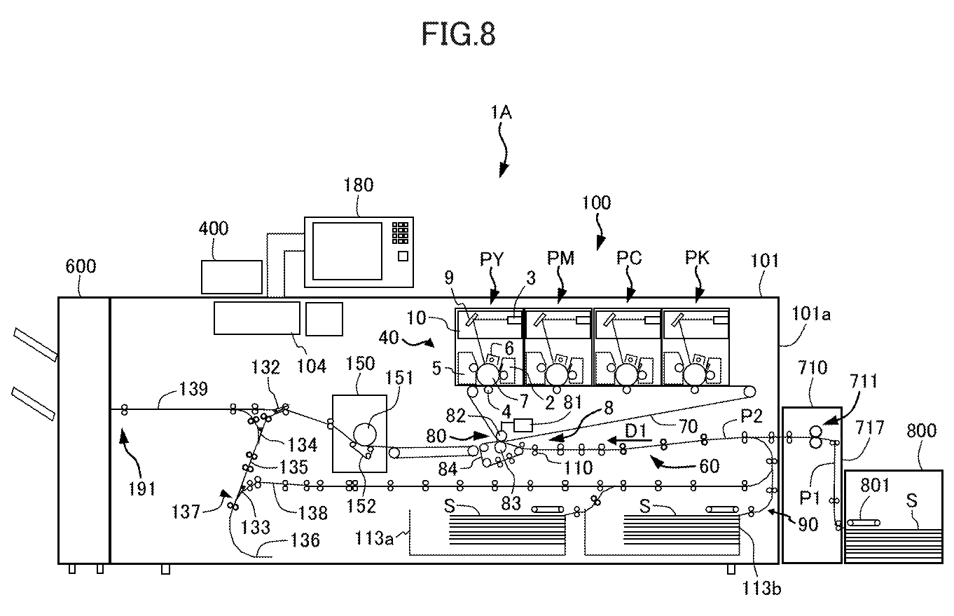

Next, a second embodiment will be described with reference to FIGS. 8 to 11. The present embodiment differs from the first embodiment in that an image forming system 1A does not include a sheet destaticizing apparatus. The other configurations are similar to the first embodiment, such that the same reference numbers are assigned to corresponding components, and descriptions thereof are omitted.

At first, a schematic configuration of the image forming system 1A will be described with reference to FIG. 8. FIG. 8 is a cross-sectional view of the image forming system 1A. The image forming system 1A includes the sheet feeding apparatus 800, a sheet charging apparatus 710, the image forming apparatus 100, and the sheet discharging apparatus 600, which are connected in the named order. The sheet charging apparatus 710 and the image forming apparatus 100 are connected such that the sheet S is conveyed from a sheet charging unit 711 to the secondary transfer portion 8.

### Image Forming Apparatus

The image forming apparatus 100 includes the second casing 101, a second conveyance path P2 disposed in the second casing 101 and through which the sheet S having been conveyed via a first conveyance path P1 of the sheet charging apparatus 710 is conveyed, the image forming unit 40, and the sheet feeding unit 90. The image forming unit 40 includes the intermediate transfer belt 70 and the secondary transfer portion 8, and forms a toner image on the sheet. The intermediate transfer belt 70 is an example of an image bearing member that bears a toner image. The secondary transfer portion 8 is an example of a transfer portion, and transfers the toner image formed on the intermediate transfer belt 70 from the intermediate transfer belt 70 onto the sheet S conveyed on the second conveyance path P2. The sheet feeding unit 90 is an example of a second sheet feeding unit disposed inside the second casing 101, and feeds the sheet supported on the sheet cassettes 113a and 113b toward the second conveyance path P2. According further to the present embodiment, the image forming apparatus 100 includes an air discharge portion not shown that sets the interior of the second casing 101 to negative pressure, and an air intake port not shown disposed on a side surface portion 101a of the second casing 101 facing the sheet charging apparatus 710. Thereby, air is taken into the interior of the second casing 101 through the air intake port, and flow of air within the image forming apparatus 100 is prevented from blowing toward the sheet charging apparatus 710, such that occurrence of soiling by toner in the interior of the sheet charging apparatus 710 may be suppressed.

### Sheet Charging Apparatus

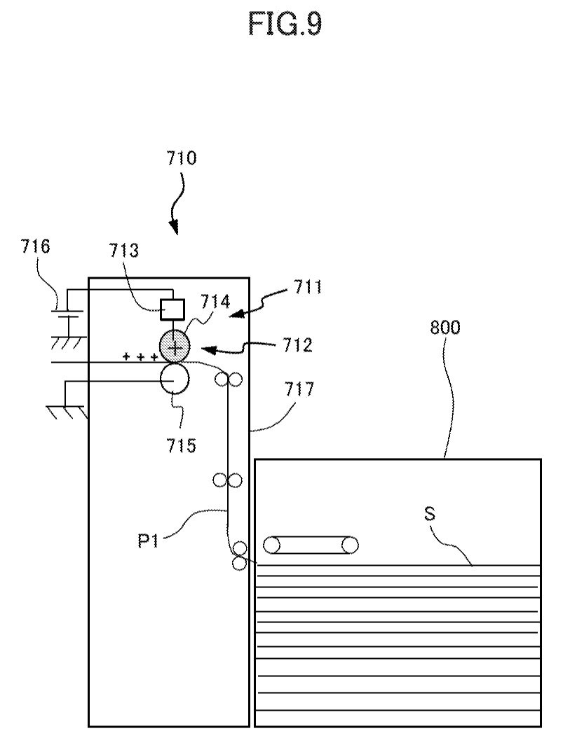

Next, the sheet charging apparatus 710 will be described with reference to FIG. 9. As illustrated in FIG. 9, the sheet charging apparatus 710 includes a first casing 717, the first conveyance path P1 disposed inside the first casing 717 and through which the sheet S is conveyed, and the sheet charging unit 711 disposed inside the first casing 717 for charging the sheet conveyed on the first conveyance path P1. The first casing 717 is a separate member that differs from the second casing 101 of the image forming apparatus 100, and in the present embodiment, the first casing 717 is connected to the second casing 101. That is, the second casing 101 receives the sheet discharged from the first casing 717.

The sheet charging unit 711 is an example of a charging unit for charging the sheet S, and includes a charging roller pair 712 that nips and conveys the sheet S, and a second voltage adjustment portion 713 that adjusts the voltage between rollers of the charging roller pair 712. The charging roller pair 712 includes a sheet charging roller 714 and a sheet charging counter roller 715. The sheet charging counter roller 715 is connected to the earth. The sheet charging roller 714 is connected via the second voltage adjustment portion 713 to a high voltage power supply 716. The second voltage adjustment portion 713 adjusts the voltage between rollers of the charging roller pair 712. The sheet charging unit 711 charges the sheet S by having a DC bias of positive polarity applied at a timing at which the sheet S passes through the nip of the charging roller pair 712 according to a value set in advance based on the sheet type and the apparatus environment. According to the present embodiment, the sheet charging unit 711 performs charging such that the printing surface of the sheet S is charged to positive polarity.

There are increasing cases where image forming is performed to sheets having high resistance values, such as synthetic paper and super-thick paper, and in order to perform secondary transfer to such high-resistance sheets, it is necessary to output an extremely high transfer voltage to maintain an appropriate transferability. Therefore, there is a risk that the output value of the secondary transfer high voltage may be insufficient when using a sheet having a high resistance value. Therefore, in order to compensate for the lack of secondary transfer high voltage, Japanese Patent Application Laid-Open Publication No. 2013-171282 discloses an image forming apparatus that is equipped with a sheet charging apparatus that charges the sheet prior to being subjected to a secondary transfer process in advance, to thereby reduce the output value of the secondary transfer high voltage compared to a case where the sheet is not charged in advance.

However, the sheet charging apparatus described above is disposed near the secondary transfer portion within the casing of the image forming apparatus. According to a configuration in which the sheet charging unit is arranged in the vicinity of the secondary transfer portion within the same casing, the sheet charging unit is subjected to application of bias and the sheet charging unit has an electric field polarity, such that the toner images on the intermediate transfer belt before being transferred or the toner particles floating within the apparatus tends to be drawn to the sheet charging unit. Therefore, the sheet charging unit may be soiled with toner. If the sheet charging unit is soiled with toner, during charging of the sheet, toner may be transferred from the sheet charging unit and attached to the sheet, causing soiling of the sheet and failure of the image, or the toner attached to the sheet charging unit may cause irregular resistance of the roller, which may lead to irregular charging and formation of defective images. Therefore, according to the present embodiment, the charging member of the sheet charging apparatus for charging the sheets is prevented from being soiled with toner prior to the transfer of toner image onto the sheet.

In the present embodiment, the sheet charging apparatus 710 has the sheet charging unit 711 accommodated in the first casing 717, which is different from the second casing 101 of the image forming apparatus 100, as illustrated in FIGS. 8 and 9. Thereby, the soiling of the charging roller pair 712 by toner from the second casing 101 may be suppressed.

The sheet feeding apparatus 800 is an example of a first sheet feeding unit, which is disposed upstream of the sheet charging unit 711 in the sheet conveyance direction in the first conveyance path P1, and which feeds the supported sheet S toward the first conveyance path P1.

### Sheet Charging Operation Procedure

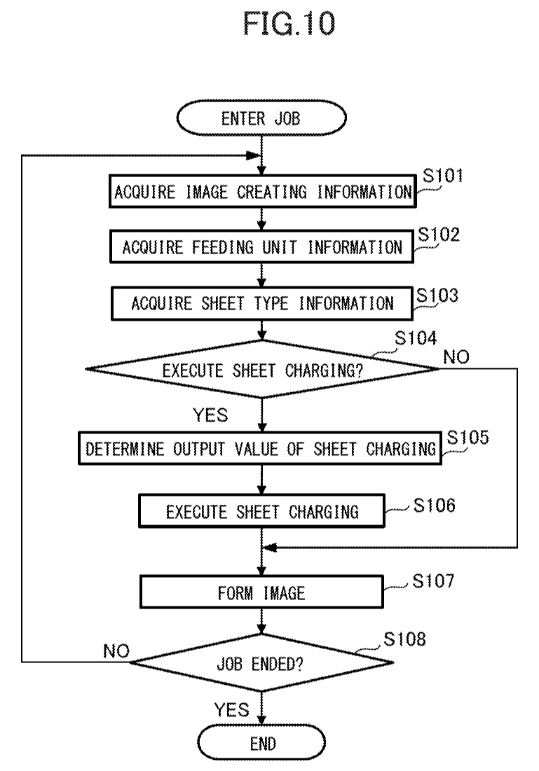

Next, a sheet charging operation procedure according to the present embodiment will be described with reference to a flowchart illustrated in FIG. 10. At first, when an image forming job is entered by a user through the operation portion 180 (refer to FIG. 8) and image forming is started, the control unit 104 acquires an image creating information including image information and number of prints of the image forming job entered by the user (S101). The control unit 104 acquires the information of the sheet feeding unit selected by the user (S102), and acquires the sheet type information to be used selected by the user (S103).

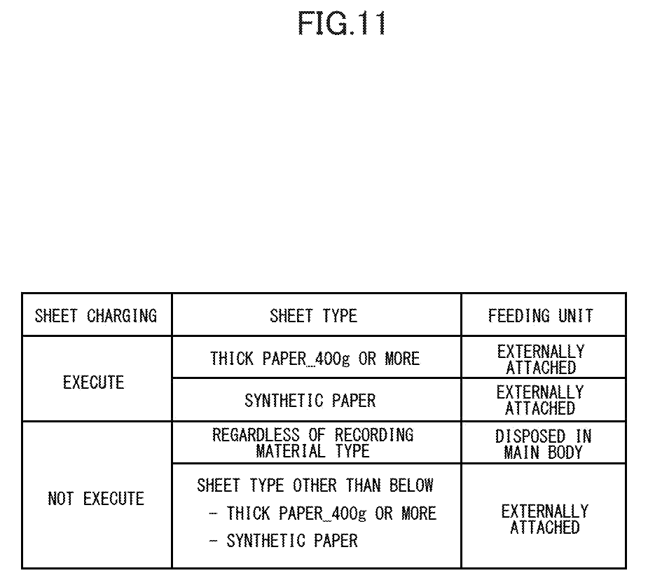

The control unit 104 determines whether to execute sheet charging based on the information acquired in S102 and S103 (S104). In this state, the control unit 104 determines whether to execute sheet charging based, for example, on conditions illustrated in FIG. 11. For example, if the sheet feeding apparatus 800 is selected in S102 and a thick paper of 400 g or more is selected as the sheet type in S103, bias is applied to the charging roller pair 712 when a sheet is passed through the sheet charging unit 711 so as to satisfy the execution conditions of sheet charge illustrated in FIG. 11. Meanwhile, for example, if the sheet feeding unit 90 is selected in S102, or if a sheet other than the thick paper of 400 g or more or synthetic paper is selected as the sheet type in S103, the condition for not executing the sheet charge is satisfied, as illustrated in FIG. 11. Therefore, charging of the sheet is not executed when a sheet is passed through the sheet charging unit 711, and application of bias to the charging roller pair 712 is not performed. According to the present embodiment, thick paper of 400 g or more and synthetic paper cannot be fed by the sheet feeding unit 90, such that when using a thick paper of 400 g or more and synthetic paper, the sheet feeding apparatus 800 that is externally attached must be selected. The conditions illustrated in FIG. 11 are merely an example, and the execution conditions and non-execution conditions of sheet charging are not limited thereto.

When sheet charging is not executed and sheet feeding is performed from the sheet feeding unit 90 based on the execution conditions of sheet charging illustrated in FIG. 11 (S104; NO), the control unit 104 executes image forming without executing sheet charging (S107). Further, when sheet charging is not executed and sheet feeding is performed from the sheet feeding apparatus 800 based on the execution conditions of sheet charging illustrated in FIG. 11 (S104; NO), the control unit 104 causes the sheet S to be sent via the sheet charging unit 711 of the sheet charging apparatus 710 to the image forming apparatus 100. In this state, when the sheet S passes through the sheet charging unit 711, no bias is applied to the charging roller pair 712 when the sheet S is conveyed to the image forming apparatus 100. That is, the control unit 104 can execute a second mode of transferring the toner image by the secondary transfer portion 8 to a sheet not charged by the sheet charging unit 711.

When executing sheet charging based on the execution condition of sheet charging illustrated in FIG. 11 (S104; YES), the control unit 104 determines the output value of sheet charging (S105). The output value is set in advance in a table value according to the sheet type and the apparatus environment, and a constant current value of the current according to the table value is set as the output value. The control unit 104 executes charging of the sheet by applying the output value determined in S105 to the charging roller pair 712 at a timing at which the sheet arrives at the sheet charging unit 711 (S106). As an example of the output value of sheet charging, when a thick paper having a grammage of 400 g is disposed and used in the sheet feeding apparatus 800, the output value to the thick paper of 400 g set according to the table value described above under the environment in which the apparatus is placed was 30 μA. The control unit 104 executes image forming after executing sheet charging (S107). That is, the control unit 104 can execute a first mode of transferring the toner image at the secondary transfer portion 8 to the sheet charged by the sheet charging unit 711.

That is, the control unit 104 switches between a first mode and a second mode based on a sheet information including a sheet type of the sheet being conveyed and executes a mode selected between the first mode and the second mode. According further to the present embodiment, the control unit 104 can select between a first mode and a second mode and execute the selected mode in a case where the sheet S is fed from the sheet feeding apparatus 800, and can execute the second mode in a case where the sheet S is fed from the sheet feeding unit 90.

After image forming, the control unit 104 determines whether the image forming job has ended (S108). When it is determined that the image forming job is ended (S108; YES), the control unit 104 ends the processing. When it is determined that the image forming job is not ended (S108; NO), the control unit 104 acquires the image creating information again (S101), and the above-described process is repeatedly performed.

As described above, according to the image forming system 1A of the present embodiment, the first casing 717 of the sheet charging apparatus 710 accommodating the sheet charging unit 711 is formed as a separate body as the second casing 101 of the image forming apparatus 100 accommodating the secondary transfer portion 8. Therefore, appropriate sheet charging may be executed without causing the charging roller pair 712 to be soiled with toner from the image forming apparatus 100 and causing image defects. In other words, a new technique regarding the image forming system 1A equipped with the secondary transfer portion 8 and the sheet charging unit 711 can be acquired.

According further to the present embodiment, the image forming apparatus 100 includes an air intake port disposed on the side surface portion 101a facing the sheet charging apparatus 710 in the second casing 101. Thereby, air can be taken into the second casing 101 through the air intake port, and the flow of air within the image forming apparatus 100 can be prevented from blowing toward the sheet charging apparatus 710. Thereby, the entry of scattered toner from the image forming apparatus 100 to the sheet charging apparatus 710 may be suppressed, and the occurrence of toner soiling inside the sheet charging apparatus 710 may be suppressed.

### Third Embodiment

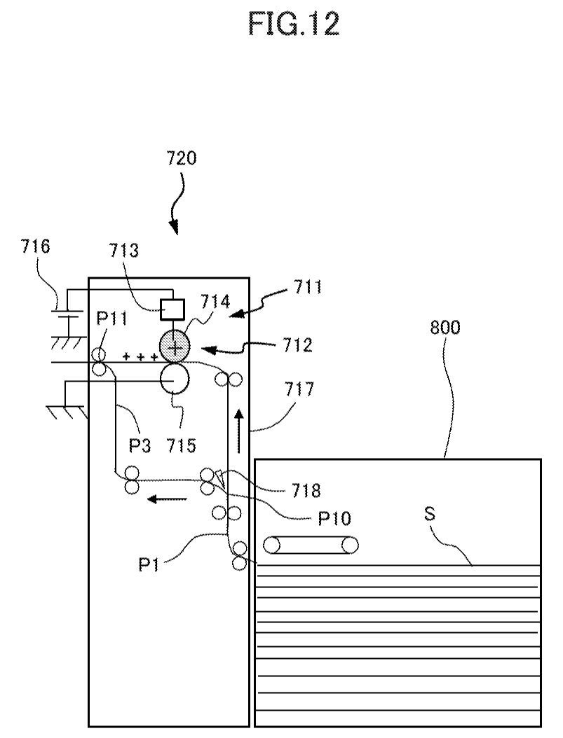

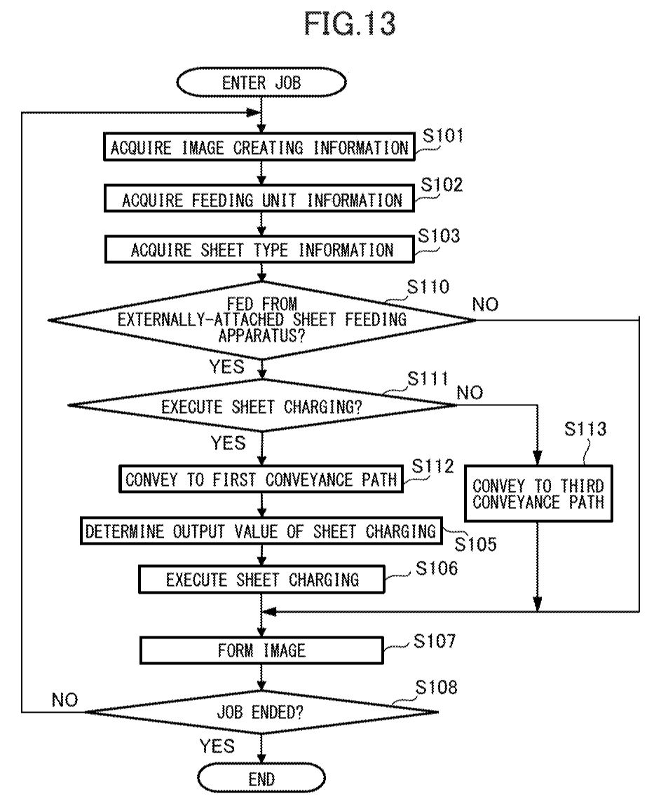

Next, a third embodiment will be described with reference to FIGS. 12 and 13. The present embodiment differs from the first and second embodiments in that a sheet charging apparatus 720 includes a third conveyance path P3 in addition to the first conveyance path P1. The other configurations are similar to the first and second embodiments, such that the same reference numbers are assigned to corresponding components, and descriptions thereof are omitted.

A schematic configuration of the sheet charging apparatus 720 according to the present embodiment will be described with reference to FIG. 12. FIG. 12 is a cross-sectional view of the sheet charging apparatus 720. The sheet charging apparatus 720 includes the first conveyance path P1, the third conveyance path P3 that differs from the first conveyance path P1, and a switching portion 718. The first conveyance path P1 includes a branching portion P10 arranged upstream of the sheet charging unit 711 in the sheet conveyance direction, and a merging portion P11 arranged downstream of the sheet charging unit 711 in the sheet conveyance direction. The third conveyance path P3 connects the branching portion P10 and the merging portion P11 without interposing the sheet charging unit 711.

The switching portion 718 is disposed pivotably in the branching portion P10, and is capable of switching the conveyance path of the sheet fed from the sheet feeding apparatus 800 between the first conveyance path P1 and the third conveyance path P3 by pivoting. The branching portion P10 is a portion where the first conveyance path P1 and the third conveyance path P3 are branched at an area upstream of the sheet charging unit 711 in the sheet conveyance direction of the first conveyance path P1 and downstream of the sheet feeding apparatus 800 in the sheet conveyance direction. The merging portion P11 is a portion where the first conveyance path P1 and the third conveyance path P3 are merged at an area downstream of the sheet charging unit 711 in the sheet conveyance direction of the first conveyance path P1 and upstream of the second conveyance path P2 in the sheet conveyance direction.

### Sheet Charging Operation Procedure

Next, a sheet charging operation procedure according to the present embodiment will be described with reference to a flowchart illustrated in FIG. 13. The operations similar to the flowchart illustrated in FIG. 10 are denoted with the same reference numbers, and descriptions thereof are omitted.

The control unit 104 acquires the image creating information, information on the selected sheet feeding unit, and sheet type information (S101 to S103), and determines whether to perform sheet feeding from the externally-attached sheet feeding apparatus 800 based on the information of the sheet feeding unit to be used (S110). In a state where feeding of sheets is not performed from the externally-attached sheet feeding apparatus 800 (S110; NO), the control unit 104 executes image forming without executing sheet charging (S107). That is, the control unit 104 is capable of executing a second mode for transferring the toner image by the secondary transfer portion 8 to a sheet that is not charged by the sheet charging unit 711.

If it is determined that sheet feeding is performed from the externally-attached sheet feeding apparatus 800 (S110; YES), the control unit 104 determines whether to execute sheet charging based on the sheet type information acquired in S103 (S111). The control unit 104 determines whether to execute sheet charging based on the conditions illustrated in FIG. 11, for example. The determination is similar to S104 of FIG. 10, such that detailed descriptions thereof are omitted.

If it is determined that sheet charging is to be performed (S111: YES), the control unit 104 switches the switching portion 718 and conveys the sheet to the first conveyance path P1 (S112). The sheet is conveyed via the first conveyance path P1 and sent to the sheet charging unit 711. Thereafter, the sheet is processed similarly as in the flowchart of FIG. 10 (S105 to S106), and image forming is executed (S107). That is, the control unit 104 is capable of executing the first mode of transferring the toner image at the secondary transfer portion 8 to the sheet charged by the sheet charging unit 711, and when executing the first mode, the sheet is conveyed via the first conveyance path P1 toward the second conveyance path P2.

Meanwhile, if it is determined that sheet charging is not to be performed (S111; NO), the sheet is fed from the sheet feeding apparatus 800, such that the control units 104 switches the switching portion 718 and conveys the sheet via the third conveyance path P3 (S113). Thereby, the sheet is conveyed to the image forming apparatus 100 without passing through the sheet charging unit 711, and image forming is executed (S107). That is, the control unit 104 is capable of executing the second mode of transferring the toner image at the secondary transfer portion 8 to the sheet that is not charged by the sheet charging unit 711, and when executing the second mode, the sheet is conveyed via the third conveyance path P3 toward the second conveyance path P2. The operation procedures after image forming are similar to the second embodiment illustrated in FIG. 10.

As described above, according to the sheet charging apparatus 720 of the present embodiment, when sheet charging is not performed when feeding the sheet from the externally-attached sheet feeding apparatus 800, the sheet is conveyed via the third conveyance path P3 that does not pass through the sheet charging unit 711. Therefore, soiling of the sheet charging unit 711 that may occur by paper dust and the like created by the sheet coming into contact with the sheet charging unit 711 during conveyance or the shortening of life of components caused by deterioration of the surface of the sheet charging unit 711 may be suppressed.

According further to the present embodiment, the first casing 717 of the sheet charging apparatus 720 accommodating the sheet charging unit 711 is formed as a separate body as the second casing 101 of the image forming apparatus 100 accommodating the secondary transfer portion 8. Therefore, the charging roller pair 712 can perform appropriate sheet charging without causing image defects that is caused by soiling of the charging roller pair 712 by toner being scattered from the image forming apparatus 100. That is, a new technique regarding the image forming system equipped with the secondary transfer portion 8 and the sheet charging unit 711 can be acquired.

### Fourth Embodiment

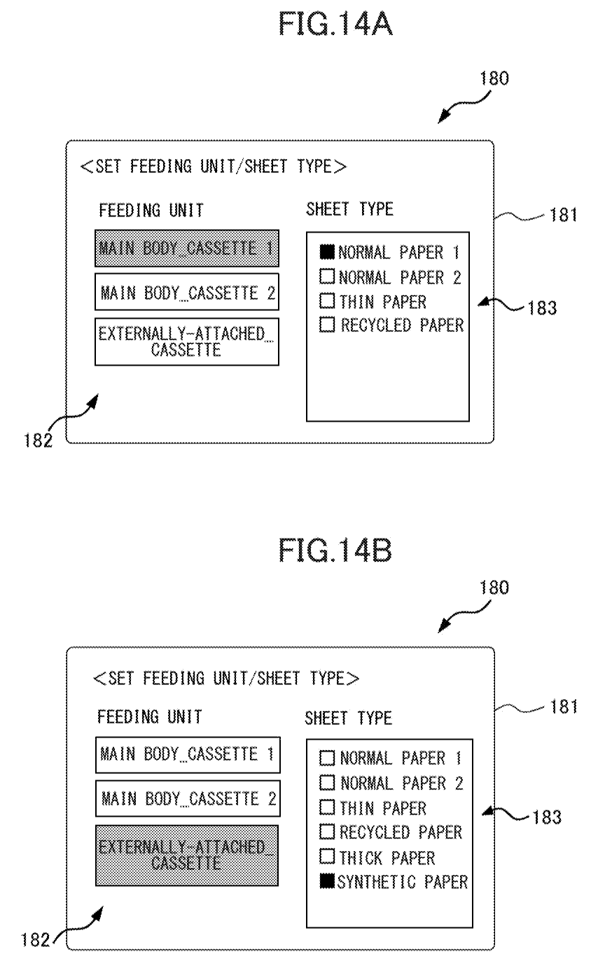

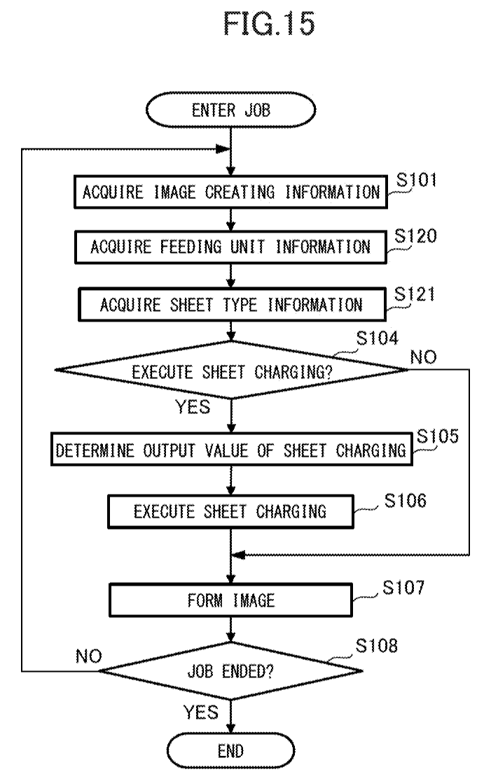

Next, a fourth embodiment will be described with reference to FIGS. 14 and 15. The present embodiment differs from the first and second embodiments in that sheet types may be set for each sheet feeding unit in the operation portion 180. The other configurations are similar to the first and second embodiments, such that the same reference numbers are assigned to corresponding components, and descriptions thereof are omitted.

For example, according to the second embodiment, the sheet charging apparatus 710 is accommodated in a casing that differs from that of the image forming apparatus 100, such that a sheet having a high resistance value to be subjected to sheet charging must be passed through the sheet charging unit 711. In contrast, if the sheet having a high resistance value to be subjected to sheet charging is set in the sheet feeding unit 90 disposed inside the image forming apparatus 100, the sheet cannot be charged since the sheet is not passed through the sheet charging apparatus 710. Therefore, in order to pass the sheet having a high resistance value to be subjected to sheet charging through the sheet charging apparatus 710 to charge the sheet, it is necessary to set the sheet in the sheet feeding apparatus 800 which is different from the image forming apparatus 100, and to have the sheet pass through the sheet charging apparatus 710.

For example, when executing image forming, the user designates the sheet type to be used and the sheet feeding unit used to feed the sheet of the designated sheet type through the operation portion 180 (refer to FIG. 8), and starts the image forming process. However, if a sheet having a high resistance value to be subjected to sheet charging is set in the sheet feeding unit 90 of the image forming apparatus 100, even if the user selects the sheet through the operation portion 180, the sheet will not be passed through the sheet charging unit 711. Therefore, sheet charging will not be executed even if the sheet to be subjected to sheet charging is selected, such that image defects may occur and appropriate image output may not be obtained. The present embodiment enables the user to select the appropriate sheet type using the operation portion 180, and avoids the sheet to be subjected to sheet charging from being output without being charged.

### Sheet Charging Apparatus

The sheet charging apparatus 710 according to the present embodiment has the sheet charging unit 711 accommodated in the first casing 717 which is separate from the second casing 101 of the image forming apparatus 100. Therefore, the configuration suppresses toner scattered inside the second casing 101 from entering the sheet charging apparatus 710, and prevents soiling of the sheet charging unit 711 by toner.

The sheet type to be subjected to sheet charging is set in advance in the control unit 104, and in the present embodiment, whether to execute sheet charging according to the sheet type is set as illustrated in FIG. 11. For example, if thick paper with a grammage of 400 g or more or synthetic paper is selected as the sheet type, sheet charging is executed by the sheet charging apparatus 710 during image forming.

### Sheet Feeding Unit

In the present embodiment, as illustrated in FIG. 8, the sheet feeding unit 90 disposed in the image forming apparatus 100 includes a first sheet cassette 113a and a second sheet cassette 113b, and sheets can be fed from each of the sheet cassettes. Sheets can also be fed from the externally-attached sheet feeding apparatus 800. Therefore, the user can select either the first sheet cassette 113a, the second sheet cassette 113b, or the sheet feeding apparatus 800 as the sheet feeding unit. Further, the user can set the sheet type accommodated in each of the sheet feeding units through the operation portion 180 to the control unit 104.

### Operation Portion

The operation portion 180 is also an example of a display portion for displaying information, which is composed of a liquid crystal panel, for example, and the user may enter information related to the sheet feeding unit for feeding sheets and the sheet type. A screen 181 displayed on the operation portion 180 according to the present embodiment is described with reference to FIGS. 14A and 14B. FIGS. 14A and 14B are each a view illustrating the screen 181 of the operation portion 180 when selecting the sheet feeding unit and the sheet type.

A sheet feeding unit selecting portion 182 and a sheet type selecting portion 183 are displayed on the screen 181. According to the present embodiment, the first sheet cassette 113a, i.e., “main body_cassette 1” in the FIGS. 14A and 14B, the second sheet cassette 113b, i.e., “main body_cassette 2” in the FIGS. 14A and 14B, and the sheet feeding apparatus 800, i.e., “externally-attached_cassette” in the FIGS. 14A and 14B, are displayed in the sheet feeding unit selecting portion 182, and the cassettes can be selected by the user through touching of the screen. According to the present embodiment, a maximum of six sheet types, which are normal paper 1, normal paper 2, thin paper, recycled paper, thick paper, and synthetic paper, may be displayed in the sheet type selecting portion 183, and the sheet type can be selected by the user through touching of the screen.

The user selects the sheet feeding unit in which the sheets to be used for image forming is set on the sheet feeding unit selecting portion 182, and thereafter, selects the sheet type from among the sheet types feedable from the selected sheet feeding unit on the sheet type selecting portion 183. FIG. 14A illustrates the sheet feeding unit selecting portion 182 and the sheet type selecting portion 183 in a case where the first sheet cassette 113a is selected, and FIG. 14B illustrates the sheet feeding unit selecting portion 182 and the sheet type selecting portion 183 in a case where the sheet feeding apparatus 800 is selected.

The sheet type of the sheet to be subjected to sheet charging is set in advance in the control unit 104 (refer to FIG. 11). Further according to the present embodiment, the sheet charging apparatus 710 is disposed as an apparatus serving as a separate unit as the image forming apparatus 100. As illustrated in FIG. 14B, in a state where the sheet feeding apparatus 800 is selected as the sheet feeding unit for feeding sheets via the operation portion 180, the sheets can pass through the sheet charging unit 711. Therefore, in the sheet type selecting portion 183, both the sheet type to which charging is to be executed and the sheet type to which charging is not to be executed can be displayed as the sheet type.

In contrast, if the sheet feeding unit disposed inside the image forming apparatus 100 is selected through the operation portion 180 as the sheet feeding unit for feeding sheets, the sheets are not passed through the sheet charging unit 711, such that sheet charging cannot be executed. Therefore, as illustrated in FIG. 14A, when the sheet feeding unit disposed inside the image forming apparatus 100 is selected, thick paper of 400 g or more and synthetic paper, which are sheet types to be subjected to sheet charging illustrated in FIG. 11, are not displayed as choices of sheet type in the sheet type selecting portion 183. According to the present embodiment, choices such as thin paper and synthetic paper are not displayed in the sheet type selecting portion 183 such that they cannot be selected, but the present embodiment is not limited thereto. For example, it may be possible to have choices such as thick paper and synthetic paper displayed, while a selecting function of such choices may be disabled such that the user cannot select such sheet types even by touching the screen.

That is, for example, a thick paper having a grammage of a predetermined value (such as 400 g) or more is set as a first sheet type, and paper having a grammage less than 400 g is set as a second sheet type. In this case, the control unit 104 displays the first sheet type and the second sheet type on the operation portion 180 as types of sheets that feedable from the externally-attached sheet feeding apparatus 800. Further, the control unit 104 displays the second sheet type in a selectable manner on the operation portion 180 as the sheet type that may be fed from the sheet feeding unit 90 disposed inside the image forming apparatus 100, while the first sheet type is not displayed selectably in the operation portion 180.

### Sheet Charging Operation Procedure

Next, a sheet charging operation procedure according to the present embodiment will be described with reference to a flowchart illustrated in FIG. 15. Operations similar to the flowchart of FIG. 10 are denoted with the same reference numbers, and detailed descriptions thereof are omitted.

Prior to having an image forming job entered by the user through the operation portion 180, the control unit 104 displays the screen 181 as illustrated in FIGS. 14A and 14B in the operation portion 180, and the user enters a sheet feeding unit information and the sheet type information. In a state where the sheet feeding apparatus 800 is selected as illustrated in FIG. 14B, the control unit 104 displays both the sheet types to be subjected to sheet charging and sheet types not subjected to sheet charging as choices in the sheet type selecting portion 183. Further, in a state where the sheet feeding unit within the image forming apparatus 100 is selected, as illustrated in FIG. 14A, the control unit 104 does not display the sheet types to be subjected to sheet charging as choices in the sheet type selecting portion 183. In this state, the control unit 104 displays the sheet types not subjected to sheet charging as choices. The entry of such sheet feeding unit information and sheet type information may be performed by the user when the user enters the image forming job through the operation portion 180.

When the image forming job is entered by the user through the operation portion 180 and image forming is started, the control unit 104 acquires image creating information, such as image information and number of prints of the image forming job entered by the user (S101). The control unit 104 acquires the information of the sheet feeding unit selected by the user (S120), and acquires the information of the sheet type to be used selected by the user (S121).

The control unit 104 determines whether to execute sheet charging based on the information acquired in S120 and S121 (S104). That is, the control unit 104 determines whether to execute sheet charging based on the information of the sheet feeding unit and the sheet type set by the user through the operation portion 180, and the conditions illustrated in FIG. 11. The subsequent operation procedures are similar to the flowchart illustrated in FIG. 10, such that detailed descriptions thereof are omitted.

Similarly, according to the present embodiment, the control unit 104 can select and execute a first mode of transferring a toner image to a sheet charged by the sheet charging unit 711 and a second mode of transferring a toner image to a sheet not charged by the sheet charging unit 711. Further, the control unit 104 switches between the first mode and the second mode based on the sheet information including the sheet type being conveyed and the sheet feeding unit information regarding which of the sheet feeding unit 90 and the sheet feeding apparatus 800 is used to feed the sheet, and executes the selected mode.

As described above, according to the operation portion 180 of the present embodiment, when the user selects the sheet feeding unit 90 of the image forming apparatus 100 on the screen 181, the sheet types that are set in advance to be subjected to sheet charging is not displayed so as not to be selected. Therefore, when a sheet feeding unit that cannot execute sheet charging is selected, image defects that occur by selecting a sheet type to be subjected to sheet charging will not be caused, and appropriate sheet charging may be executed. That is, the users are enabled to select appropriate sheet types using the operation portion 180, such that sheets to be subjected to sheet charging are prevented from being output without being charged.

Similarly, according to the present embodiment, the first casing 717 of the sheet charging apparatus 710 accommodating the sheet charging unit 711 is formed as a separate body as the second casing 101 of the image forming apparatus 100 accommodating the secondary transfer portion 8. Therefore, appropriate sheet charging may be executed without causing image defects due to soiling of the charging roller pair 712 by the toner scattered from the image forming apparatus 100. Therefore, a new technique regarding an image forming system equipped with the secondary transfer portion 8 and the sheet charging unit 711 may be acquired.

### Fifth Embodiment

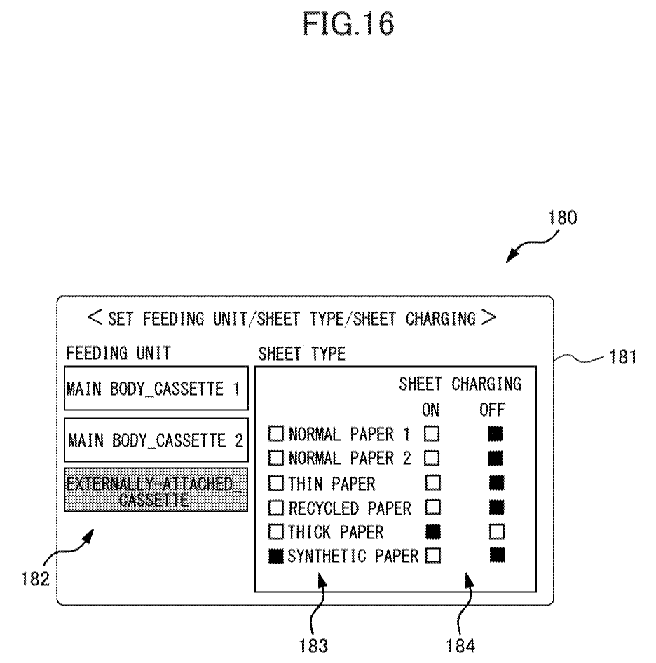

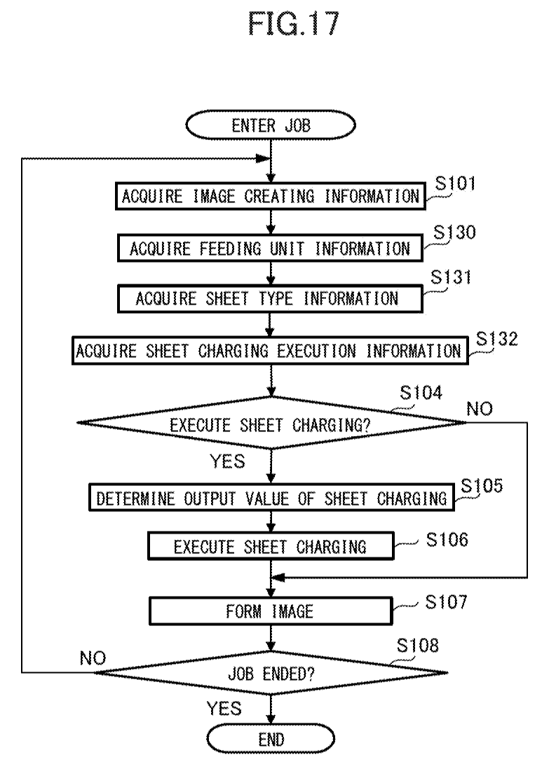

Next, a fifth embodiment will be described with reference to FIGS. 16 and 17. The present embodiment differs from the fourth embodiment in that whether to execute sheet charging may be set per sheet type in the operation portion 180. The other configurations are similar to the second and fourth embodiments, such that the same reference numbers are assigned to corresponding components, and descriptions thereof are omitted.

For example, according to the second and fourth embodiments, the control unit 104 includes a table regarding whether to execute sheet charging per sheet type (refer to FIG. 11), and whether to execute sheet charging is determined based on the table. In the table, the sheet types having a high resistance value, such as synthetic paper, are set as the sheet types to which sheet charging is executed. However, some brands of synthetic paper have relatively low resistance values, and when such synthetic paper is used, in some cases, a better image may be obtained when sheet charging is not executed. That is, if whether to execute sheet charging is set in a fixed manner corresponding to the sheet types, there may be cases where image defects occur and a suitable output image cannot be obtained. Therefore, according to the present embodiment, whether to execute sheet charging can be selected per sheet type to which image forming is performed, to thereby suppress the occurrence of image defects.

In the present embodiment, the image forming apparatus 100, the sheet charging apparatus 710, and the sheet feeding apparatus 800 are similar to those according to the second embodiment illustrated in FIG. 8. Therefore, in the following description, the screen 181 displayed on the operation portion 180 and the sheet charging operation procedure will be described.

### Operation Portion

The screen 181 displayed on the operation portion 180 of the present embodiment will be described with reference to FIG. 16. FIG. 16 is a view illustrating the screen 181 for selecting whether to execute sheet charging per sheet type when the sheet feeding apparatus 800 is selected.

The sheet feeding unit selecting portion 182, the sheet type selecting portion 183, and a sheet charging selecting portion 184 are displayed on the screen 181. According to the present embodiment, the first sheet cassette 113a, i.e., “main body_cassette 1” in the FIG. 16, the second sheet cassette 113b, i.e., “main body_cassette 2” in the FIG. 16, and the sheet feeding apparatus 800, i.e. “externally-attached_ cassette” in the FIG. 16, are displayed in the sheet feeding unit selecting portion 182, and the cassettes can be selected by the user through touching of the screen. According to the present embodiment, a maximum of six sheet types, which are normal paper 1, normal paper 2, thin paper, recycled paper, thick paper, and synthetic paper, may be displayed in the sheet type selecting portion 183, and the sheet type can be selected by the user through touching of the screen. The sheet charging selecting portion 184 is displayed when the sheet feeding apparatus 800 is selected in the sheet feeding unit selecting portion 182, wherein whether to execute (ON) or not to execute (OFF) sheet charging is displayed per sheet type, and the choices can be selected by the user through touching of the screen.

The user can select the sheet feeding unit in which the sheets to be used for image forming is set in the sheet feeding unit selecting portion 182. When the first sheet cassette 113a or the second sheet cassette 113b is selected in the sheet feeding unit selecting portion 182, the sheet type selecting portion 183 is displayed similarly as in the fourth embodiment (refer to FIG. 14A), and the sheet charging selecting portion 184 is not displayed. The sheet charging selecting portion 184 is not displayed since sheet charging cannot be performed to sheets in the first sheet cassette 113a and the second sheet cassette 113b, such that there is no need to display choices.

As illustrated in FIG. 16, when the sheet feeding apparatus 800 is selected in the sheet feeding unit selecting portion 182, the sheet type selecting portion 183 and the sheet charging selecting portion 184 are displayed. In the sheet charging selecting portion 184, whether to execute (ON) or not to execute (OFF) sheet charging is displayed per sheet type displayed in the sheet type selecting portion 183, and the choices can be selected by the user through touching of the screen. Thereby, for example, if the synthetic paper has a relatively low resistance value, sheet charging thereof may be set not to be executed, such that an appropriate output image may be obtained. That is, the control unit 104 selectably displays on the screen 181 of the operation portion 180 whether to execute charging by the sheet charging unit 711 per sheet type that may be fed from the sheet feeding apparatus 800.

### Sheet Charging Operation Procedure

Next, the sheet charging operation procedure according to the present embodiment will be described with reference to the flowchart illustrated in FIG. 17. The operations similar to those illustrated in FIG. 10 are denoted with the same reference numbers, and descriptions thereof are omitted.

Prior to having an image forming job entered by the user through the operation portion 180, the control unit 104 displays the screen 181 as illustrated in FIG. 14A or FIG. 16 on the operation portion 180, and the user selects the sheet feeding unit. As illustrated in FIG. 14A, in a state where the sheet feeding unit within the image forming apparatus 100 is selected, the control unit 104 displays the sheet types to which sheet charging is not executed as choices in the sheet type selecting portion 183. On the other hand, as illustrated in FIG. 16, in a state where the sheet feeding apparatus 800 is selected, the control unit 104 displays the sheet charging selecting portion 184, and selectably displays whether to execute (ON) or not to execute (OFF) sheet charging per sheet type displayed in the sheet type selecting portion 183. The user selects and enters whether to execute or not to execute sheet charging per sheet type in the sheet charging selecting portion 184, and whether to execute (ON) or not to execute (OFF) sheet charging is acquired by the control unit 104 as execution information, or selection information, of sheet charging. The input of such sheet feeding unit information and sheet type information may also be performed when the user enters the image forming job through the operation portion 180.

When the image forming job is entered by the user through the operation portion 180 and image forming is started, the control unit 104 acquires the image creating information, such as the image information and number of prints entered by the user (S101). The control unit 104 acquires the sheet feeding unit information selected by the user (S130), and acquires the information on the sheet type to be used selected by the user (S131). Furthermore, the control unit 104 acquires the execution information of sheet charging in the sheet feeding unit selected by the user (S132).

The control unit 104 determines whether to execute sheet charging based on the information acquired in S130, S131, and S132 (S104). That is, the control unit 104 determines whether to execute sheet charging based on the sheet feeding unit and sheet type information set by the user through the operation portion 180, and based on the execution information, i.e., selection information, regarding whether to execute charging per sheet type selected by the user through the operation portion 180. The subsequent operation procedures are similar to those of the flowchart illustrated in FIG. 10, such that detailed descriptions thereof are omitted.

Similarly, according to the present embodiment, the control unit 104 can select and execute a first mode of transferring a toner image to a sheet charged by the sheet charging unit 711 and a second mode of transferring a toner image to a sheet not charged by the sheet charging unit 711. Further, in a state where the sheet feeding apparatus 800 is selected, the control unit 104 switches between the first mode and the second mode based on the sheet information including the sheet type being conveyed and the execution information having selected whether to execute charging per sheet type, and executes the selected mode.

As described above, according to the operation portion 180 of the present embodiment, whether to execute sheet charging may be set through the operation portion 180. Therefore, in the case of a synthetic paper which usually has a high resistance value, if the synthetic paper being used has a low resistance value and better images can be obtained when sheet charging is not executed, the present technique enables to obtain the optimum output product by setting the sheet charging not to be executed, such that an appropriate sheet charging may be executed. That is, the present technique enables to select whether to perform sheet charging based on the sheet type on which image forming is performed, by which occurrence of image defects may be suppressed.

Similarly, according to the present embodiment, the first casing 717 of the sheet charging apparatus 710 accommodating the sheet charging unit 711 is formed as a separate body as the second casing 101 of the image forming apparatus 100 accommodating the secondary transfer portion 8. Therefore, appropriate sheet charging may be performed without causing image defects due to soiling of the charging roller pair 712 by the toner scattered from the image forming apparatus 100. Therefore, a new technique related to an image forming system equipped with the secondary transfer portion 8 and the sheet charging unit 711 may be acquired.

Similarly, according to the present embodiment, whether to convey the sheet via the first conveyance path P1 of the sheet charging apparatus 710 or to convey the sheet via the third conveyance path P3 is determined based on whether sheet charging is executed or not. That is, in a case where sheet charging is not executed, the sheet is conveyed via the third conveyance path P3 that does not pass through the sheet charging unit 711. Therefore, soiling of the sheet charging unit 711 that may occur by paper dust and the like created by the sheet coming into contact with the sheet charging unit 711 during conveyance or the shortening of life of components caused by deterioration of the surface of the sheet charging unit 711 may be suppressed.

According to the second to fifth embodiments described above, an example has been illustrated where a DC contact current bias is applied to the sheet charging roller 714, but the present technique is not limited thereto, and alternatively, a DC constant voltage bias may be applied, or an AC current and voltage may be superposed.

According further to the second to fifth embodiments, an example has been illustrated where a positive polarity bias is applied to the sheet charging roller 714 to charge the surface of the sheet to positive polarity, but the present technique is not limited thereto. For example, the back surface of the sheet may be charged to negative polarity by applying a negative polarity bias to the sheet charging counter roller 715. Further, the present technique is not limited to using the charging roller pair 712 adopting a contact charging system, and for example, one of the rollers may be replaced with a conductive brush, or a non-contact charging system adopting corona discharge may be used.

According further to the second to fifth embodiments, the image forming system did not include a sheet destaticizing apparatus, but the present technique is not limited thereto. For example, the image forming system may further include the sheet destaticizing unit 50 disposed downstream of the secondary transfer portion 8 in the sheet conveyance direction of the sheet conveyed through the second conveyance path P2 for destaticizing the sheet conveyed from the secondary transfer portion 8 (refer to FIG. 1). In this case, the sheet destaticizing apparatus 900 includes a third casing 901 that differs from the first casing 717 and the second casing 101, and a fourth conveyance path P4 disposed inside the third casing 901 and through which the sheet received from the second conveyance path P2 is conveyed. The sheet destaticizing unit 50 is an example of a destaticizing unit, which is disposed inside the third casing 901 and destaticizes the sheet conveyed through the fourth conveyance path P4 (refer to FIG. 1). In this case, the third casing 901 of the sheet destaticizing apparatus 900 accommodating the sheet destaticizing unit 50 is formed as a separate body as the second casing 101 of the image forming apparatus 100 accommodating the secondary transfer portion 8. Therefore, appropriate sheet destaticizing may be performed without causing image defects due to soiling of the destaticizing roller pair 51 by the toner scattered from the image forming apparatus 100.

According to the present disclosure, a new technique related to an image forming system equipped with a transfer portion and a charging unit is provided.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198926, filed November 14, 2024 and No. 2025-115437, filed July 8, 2025 which are hereby incorporated by reference herein in their entirety.

What is claimed is:

1. An image forming system including:
a first casing;
a first conveyance path disposed inside the first casing and through which a sheet is conveyed;
a charging unit disposed inside the first casing and configured to charge the sheet conveyed through the first conveyance path;
a second casing configured to receive the sheet discharged from the first casing;
a second conveyance path disposed inside the second casing and through which the sheet conveyed through the first conveyance path is conveyed; and
an image forming unit configured to form a toner image on the sheet and disposed inside the second casing, the image forming unit including:
an image bearing member configured to bear the toner image; and
a transfer portion configured to transfer the toner image formed on the image bearing member from the image bearing member to the sheet conveyed through the second conveyance path.

2. The image forming system according to claim 1, further comprising:
a control unit configured to control the charging unit and the transfer portion,
wherein the control unit is configured to execute a first mode of transferring a toner image by the transfer portion to a sheet charged by the charging unit and a second mode of transferring a toner image by the transfer portion to a sheet not charged by the charging unit.

3. The image forming system according to claim 2, further comprising:
a first sheet feeding unit disposed upstream of the charging unit in a sheet conveyance direction on the first conveyance path and configured to feed a sheet supported in the first sheet feeding unit toward the first conveyance path;
a switching portion configured to switch a conveyance path of the sheet fed from the first sheet feeding unit between the first conveyance path and a third conveyance path that differs from the first conveyance path; and
a merging portion configured to merge the first conveyance path and the third conveyance path at a position downstream of the charging unit in the sheet conveyance direction on the first conveyance path and upstream of the second conveyance path in the sheet conveyance direction,
wherein the control unit is configured to convey a sheet via the first conveyance path toward the second conveyance path during execution of the first mode, and to convey a sheet via the third conveyance path toward the second conveyance path during execution of the second mode.

4. The image forming system according to claim 2, wherein the control unit is configured to switch between the first mode and the second mode based on a sheet information including a sheet type of the sheet being conveyed.

5. The image forming system according to claim 2, further comprising:
a first sheet feeding unit disposed upstream of the charging unit in a sheet conveyance direction on the first conveyance path and configured to feed a sheet supported in the first sheet feeding unit toward the first conveyance path; and
a second sheet feeding unit disposed inside the second casing and configured to feed a sheet supported in the second sheet feeding unit toward the second conveyance path,
wherein the control unit is configured to:
execute a mode selected between the first mode and the second mode in a case where the sheet is fed from the first sheet feeding unit, and
execute the second mode in a case where the sheet is fed from the second sheet feeding unit.

6. The image forming system according to claim 5, further comprising:
a display portion configured to display information,
wherein the control unit is configured to:
display a first sheet type having a grammage of a predetermined value or more and a second sheet type having a grammage less than the predetermined value selectably on the display portion as a sheet type feedable by the first sheet feeding unit; and
display the second sheet type on the display portion as a sheet type feedable by the second sheet feeding unit, and not display the first sheet type on the display portion.

7. The image forming system according to claim 6, wherein the control unit is configured to switch between the first mode and the second mode based on a sheet information including a sheet type of the sheet being conveyed and a sheet feeding unit information regarding which of the first sheet feeding unit and the second sheet feeding unit feeds the sheet.

8. The image forming system according to claim 5, further comprising:
a display portion configured to display information,
wherein the control unit is configured to display whether to execute charging by the charging unit per sheet type feedable by the first sheet feeding unit on the display portion.

9. The image forming system according to claim 8, further comprising:
an operation portion through which information may be entered,
wherein the control unit is configured to switch between the first mode and the second mode based on a sheet information including a sheet type of the sheet being conveyed and a selection information having selected whether to execute charging per sheet type selected through the operation portion.

10. The image forming system according to claim 1, wherein the charging unit is configured to charge a printing surface of a sheet to an opposite polarity as a charge polarity of toner.

11. The image forming system according to claim 1, further comprising:
a destaticizing unit disposed downstream of the transfer portion in a sheet conveyance direction of the sheet conveyed through the second conveyance path and configured to destaticize the sheet conveyed from the transfer portion.

12. The image forming system according to claim 11, further comprising:
a third casing that differs from the first casing and the second casing; and
a fourth conveyance path disposed inside the third casing and through which the sheet received from the second conveyance path is conveyed,
wherein the destaticizing unit is disposed inside the third casing and configured to destaticize the sheet being conveyed in the fourth conveyance path.

13. The image forming system according to claim 11, further comprising:
a control unit configured to control the charging unit, the transfer portion, and the destaticizing unit,
wherein the control unit is configured to execute a third mode of charging a sheet by the charging unit, transferring a toner image by the transfer portion to the sheet charged by the charging unit, and destaticizing the sheet to which the toner image has been transferred by the transfer portion via the destaticizing unit.

14. The image forming system according to claim 13, wherein the control unit is configured to execute a fourth mode of transferring a toner image by the transfer portion to a sheet not charged by the charging unit, and destaticizing the sheet to which the toner image has been transferred by the transfer portion via the destaticizing unit.

15. The image forming system according to claim 14, wherein an absolute value of a voltage set to the destaticizing unit during execution of the third mode is a first value, and an absolute value of a voltage set to the destaticizing unit during execution of the fourth mode is a second value that is greater than the first value.
